(19) United States
(12) Patent Application Publication
(10) Pub. No.: US 2023/0211898 A1
(43) Pub. Date: Jul. 6, 2023

(54) COMBINED AMMONIA-BASED MODERATOR AND PROPELLANT FOR NUCLEAR THERMAL PROPULSION STAGES

(71) Applicant: Ultra Safe Nuclear Corporation, Seattle, WA (US)

(72) Inventor: Michael John Eades, Seattle, WA (US)

(21) Appl. No.: 18/008,831

(22) PCT Filed: Aug. 17, 2021
(86) PCT No.: PCT/US2021/046274

§ 371 Date: Dec. 7, 2022

Related U.S. Application Data
(60) Provisional application No. 63/066,422, filed on Aug. 17, 2020.

(51) Int. Cl. B64G 1/40; G21C 5/12; G21D 5/02

(52) U.S. Cl. CPC B64G 1/408; G21C 5/12; G21D 5/02

(57) ABSTRACT

Combined moderator-propellant technologies allow a dual-purpose fluid to act as both a nuclear moderator as well as a propellant in a nuclear reactor system, such as a nuclear thermal propulsion (NTP) system. By increasing the mass efficiency of the NTP system and improving the overall performance during operation, the combined moderator-propellant technologies improve valuable payload efficiency in the NTP system. Advantageously, the combined moderator-propellant technologies require little to no dedicated storage space for the majority of NTP system operation. For example, the combined moderator-propellant is ammonia (NH₃), which satisfies moderation requirements as well as propulsion requirements for the NTP system.

### CROSS-REFERENCE TO RELATED APPLICATIONS

This application claims priority to U.S. Provisional Pat. Application No. 63/066,422, filed on Aug. 17, 2020, titled “Combined Ammonia-Based Moderator and Propellant for Nuclear Thermal Propulsion Stages,” the entire disclosure of which is incorporated by reference herein.

### TECHNICAL FIELD

The present subject matter relates to examples of nuclear thermal propulsion (NTP) systems and nuclear reactor systems. The present subject matter also encompasses moderation and propulsion of nuclear thermal propulsion reactors with a combined moderator-propellant.

### BACKGROUND

Conventional chemical-based propulsion systems commonly deployed in rockets rely on an oxidizer, such as oxygen, to generate a chemical reaction in order to create thrust. Nuclear thermal propulsion (NTP) systems have the potential to deliver thrust values that far exceed chemical based fuels. Typically, this is done by heating a propellant, typically low molecular weight hydrogen, to over 2,600 Kelvin by harnessing thermal energy from a nuclear reactor.

NTP is an appealing technology with prospects for becoming the propulsion system of choice for human missions beyond low earth orbit. Numerous mission architectures call NTP the preferred approach for a 2030s human Mars mission for its ability to produce significant amounts of thrust while operating at a high specific impulse.

The design of NTP systems dates back to the Nuclear Engine for Rocket Vehicle Applications (NERVA) work done by NASA. The NERVA design typically consists of a small nuclear fission reactor, turbopump assembly (TPA), nozzle, radiation shield, assorted propellant lines, pressure vessel, and support hardware. Thermal energy gained by the propellant during an expansion cycle is used to power the rocket.

In conventional NTP designs, a tank stores hydrogen (H2) as a propellant. This hydrogen propellant tank must be large enough to contain a sufficient amount of hydrogen for a mission, such as to space. Because the density and boiling point of hydrogen is not particularly high, the mass and size of the tank is usually very large. Hence, hydrogen propellant is difficult to store in a mass effective manner and small form factor within the tank.

Additionally, cryogenic equipment such as cryocoolers and multi-layer insulation (MLI) are needed to utilize the conventional hydrogen propellant. Cryogenic equipment is expensive, and thus is not conducive to a cost-effective mission, particularly in space. Accordingly, the conventional hydrogen propellant is not very cost-effective. The mass of the equipment needed for NTP systems using the conventional hydrogen propellant, including the cryogenic equipment and the tank is large and requires larger and more complex fairings for rockets to utilize the hydrogen propellant. An alternative propellant that can be stored as a dense liquid in a smaller tank that is lighter, with a smaller form factor, and with a relatively larger surface area to volume ratio compared to a hydrogen storing tank is needed.

### SUMMARY

Hence, there is room for further improvement in NTP systems and devices that incorporate such NTP systems. The combined moderator-propellant technologies disclosed herein increases the mass efficiency of an NTP system and improve the overall performance during operation. In contrast with the single purpose, non-moderating hydrogen propellant, the combined moderator-propellant technologies require little to no dedicated storage space for the majority of NTP operation. The combined moderator-propellant technologies advantageously allow a dual-purpose fluid to act as both a nuclear moderator as well as a propellant (e.g., for a rocket) in an NTP system, which makes the NTP system lighter, have a smaller form factor (less bulky), and more cost effective.

In an example, a nuclear thermal propulsion system includes a pressure vessel and a nuclear reactor core disposed in the pressure vessel. The nuclear reactor core includes a moderator region to flow a combined moderator-propellant and an array of fuel assemblies disposed within the moderator region. Each fuel assembly includes a nuclear fuel and an array of coolant channels formed within the nuclear fuel and coupled to the moderator region to flow the combined moderator-propellant to a thrust chamber. The combined moderator-propellant can include ammonia (NH₃).

Each fuel assembly can further include an insulator layer surrounding the nuclear fuel and the array of coolant channels, an inner can surrounding the insulator layer, a combined moderator-propellant return disposed surrounding the inner can, and an outer can. The combined moderator-propellant return can be located between the inner can and the outer can. The outer can may be directly coupled to the moderator region, and the insulator layer can be formed of zirconium carbide (ZrC). The pressure vessel can be formed of a titanium alloy, an aluminum stainless steel alloy, or a nickel-chromium based superalloy. The inner can may be formed of a silicon carbide/silicon carbide (SiC—SiC) composite or a zirconium alloy. The outer can may be formed of the SiC—SiC composite, a beryllium (Be) composite, or a stainless steel alloy. The nuclear fuel can be comprised of coated fuel particles embedded inside a high-temperature matrix. The high temperature matrix can include silicon carbide, zirconium carbide, titanium carbide, niobium carbide, tungsten, molybdenum, or a combination thereof. The coated fuel particles can include tristructural-isotropic (TRISO) fuel particles, bistructural-isotropic (BISO) fuel particles, or TRIZO fuel particles. The BISO fuel particles can include a fuel kernel formed of uranium nitride (UN).

The nuclear thermal propulsion system can also include a reflector region disposed between the moderator region and the pressure vessel. The reflector region can be formed of a solid reflector material. The solid reflector material can be formed of beryllium (Be) or beryllium oxide (BeO).

Alternatively or additionally, the reflector region can be configured to flow the combined moderator-propellant. The nuclear thermal propulsion system can further include a moderator reflector separator disposed between the moderator region and the reflector region. The moderator reflector separator can be formed of a silicon carbide/silicon carbide (SiC—SiC) composite, beryllium (Be), or a stainless steel alloy.

The nuclear thermal propulsion system can include a coolant plenum located inside the pressure vessel and coupled to the moderator region to store and flow the combined moderator-propellant to the moderator region. Additionally, the nuclear thermal propulsion system can include a combined moderator-propellant pump. The combined moderator-propellant pump is configured to pump the combined moderator-propellant from the coolant plenum to the moderator region, and to pump the combined moderator-propellant from the moderator region to the array of fuel assemblies.

The nuclear thermal propulsion system can further include a plurality of circumferential control drums surrounding the moderator region. Each of the control drums includes a reflector portion within a first portion of an outer surface and an absorber material within a second portion of the outer surface. The reflector portion can be formed of a solid reflector material. The solid reflector material can be formed of beryllium (Be) or beryllium oxide (BeO). Alternatively or additionally, the reflector portion can include a control drum reflector chamber configured to flow the combined moderator propellant. The control drum reflector chamber is configured to flow the combined moderator-propellant while the combined moderator-propellant is in a pressurized or a supercritical state.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

### BRIEF DESCRIPTION OF THE DRAWINGS

The drawing figures depict one or more implementations, by way of example only, not by way of limitations. In the figures, like reference numerals refer to the same or similar elements.

FIG. 1 is a notional flow diagram of a nuclear thermal propulsion system that depicts a nuclear reactor showing a combined moderator-propellant flowing through a nuclear reactor core (including a moderator region and a fuel region), a pump, a propellant tank, and other components of the NTP system.

FIG. 2A is a transverse cross-section illustration of a first variation of the combined moderator-propellant NTP nuclear reactor core of FIG. 1 that implements solid control drums and a solid reflector region.

FIG. 2B is a detail area illustration of the transverse cross-section of the combined moderator-propellant NTP nuclear reactor core of FIG. 2A.

FIG. 2C is a detail area illustration of a fuel assembly of the combined moderator-propellant NTP nuclear reactor core of FIG. 2A

FIG. 2D is a frontal cross-section illustration of an NTP system of FIGS. 2A-C that implements the combined moderator-propellant, a thrust chamber, nozzle, solid control drums, and a solid reflector region.

FIG. 3A is a transverse cross-section illustration of a second variation of the combined moderator-propellant NTP nuclear reactor core of FIG. 1 that implements control drums filled with ammonia (NH3) and a reflector region filled with ammonia.

FIG. 3B is a detail area illustration of the transverse cross-section of the combined moderator-propellant NTP nuclear reactor core of FIG. 3A.

FIG. 3C is a detail area illustration of the fuel assembly of the combined moderator-propellant NTP nuclear reactor core of FIG. 3A

FIG. 3D is a frontal cross-section illustration of an NTP system of FIGS. 3A-C that implements ammonia (NH3) filled control drums and the ammonia filled reflector region.

FIG. 4A is a line graph depicting a calculated change in velocity versus a maximum payload mass of a heavy lift vehicle utilizing an NTP system with ammonia propellant, as compared to a heavy lift vehicle utilizing a propulsion system with storable bipropellant.

FIG. 4B is a line graph depicting capabilities for calculated delta-V (change in velocity) versus the ratio of payload capability of a heavy lift vehicle utilizing an NTP system with ammonia propellant as the in-space propulsion stage compared to utilizing a storable bipropellant.

FIG. 4C is the line graph of FIG. 4A with an overlay of various representative payloads and various representative missions achievable with a given change in velocity.

FIG. 5A is a line graph depicting a calculated change in velocity versus a maximum payload mass of a medium lift vehicle utilizing an NTP system with ammonia propellant, as compared to a medium lift vehicle utilizing a propulsion system with storable bipropellant.

FIG. 5B is a line graph depicting capabilities for calculated delta-V (change in velocity) versus the ratio of payload capability of a medium lift vehicle utilizing an NTP system with ammonia propellant as the in-space propulsion stage compared to utilizing a storable bipropellant.

FIG. 6 is a line graph depicting a calculated change in velocity versus a maximum payload mass of a Europa Clipper-class vehicle utilizing an NTP system with ammonia propellant, as compared to a Europa Clipper-class vehicle utilizing a propulsion system with storable bipropellant.

FIG. 7 is a chart comparing a notional propellant tank of pressurized ammonia to a notional propellant tank of cryogenic hydrogen.

FIG. 8 is a chart comparing and contrasting the feasibility of utilizing various propulsion technologies for extraterrestrial propulsion systems.

Parts Listing

| | |
|---|---|
| 100 | Nuclear Thermal Propulsion (NTP) System |
| 101 | Nuclear Reactor Core |
| 102, 102A-B | Combined Moderator-Propellant |
| 107 | Nuclear Reactor |
| 113 | Moderator Region |
| 114 | Fuel Region |
| 120 | Combined Moderator-Propellant Flow Path |
| 140 | Combined Moderator-Propellant Pump |
| 151 | Propellant Tank |
| 170 | Thrust Chamber |
| 171 | Nozzle |
| 172 | Throat |
| 173 | Skirt |
| 204A-N | Fuel Assemblies |
| 215 | Solid Reflector Region |
| 216 | Solid Control Drum Reflector Portion |
| 217 | Control Drum Absorber Material |
| 219A-F | Control Drum Coolant Gaps |
| 220A-F | Control Drums |
| 230 | Outer Surface |
| 231 | First Portion |
| 232 | Second Portion |
| 240 | Outer Can |
| 241 | Combined Moderator-Propellant Return |
| 242 | Inner Can |
| 243 | Outer Insulator Layer |
| 244 | Nuclear Fuel |
| 245A-N | Inner Insulator Layers |
| 246A-N | Coolant Channels |
| 260 | Pressure Vessel |
| 261 | Major Coolant Plenum |
| 262 | Photon Shield |
| 263 | Neutron Shield |
| 264 | Upper Plate |
| 265 | Upper Coolant Plenum |
| 266 | Lower Plate |
| 267 | Lower Coolant Plenum |
| 268 | Inner Pressure Vessel |
| 269 | Coolant Intake Manifold |
| 270 | Bottom Plate |
| 290 | Nuclear Reactor Core Detail Area |
| 291 | Fuel Assembly Detail Area |
| 315 | Fluid Reflector Region |
| 316 | Fluid Control Drum Reflector Portion |
| 350 | Moderator Reflector Separator |
| 351A-F | Control Drum Reflector Chambers |
| 390 | Nuclear Reactor Core Detail Area |
| 391 | Fuel Assembly Detail Area |
| 400A-C | Performance Calculations Heavy Lift Vehicle Plots |
| 401 | NH3 NTP Performance Line |
| 402 | Storable Bipropellant Performance Line |
| 403 | NH₃ NTP to Storable Bipropellant Payload Ratio Line |
| 410 | Delta-V (Change in Velocity) |
| 415 | Maximum Payload Mass |
| 420 | NH3 NTP / Storable Bipropellant Payload Capabilities |
| 425A-D | Representative Missions |
| 430A-D | Representative Payloads |
| 501 | NH3 NTP Performance Line |
| 502 | Storable Bipropellant Performance Line |
| 503 | NH₃ NTP to Storable Bipropellant Payload Ratio Line |
| 600 | Performance Calculations Europa Clipper Plot |
| 601 | NH3 NTP Performance Line |
| 602 | Storable Bipropellant Performance Line |
| 625 | Jupiter Transfer Mission Equivalent |
| 700 | Representative Case 10,000 kg of Propellant Chart |
| 701 | Pressurized NH₃ Propellant |
| 702 | Cryogenic H₂ Propellant |
| 721 | Pressurized NH₃ Propellant Tank Diameter |
| 722 | Cryogenic H₂ Propellant Tank Height |
| 732 | Cryogenic H₂ Propellant Tank Diameter |
| 751 | Pressurized NH₃ Propellant Tank |
| 752 | Cryogenic H₂ Propellant Tank |
| 800 | Potential Propulsion Technology Chart |
| 802 | H₂ NTP System |
| 803 | LH₂/Liquid Oxygen (LOX) System |
| 804 | CH₄/LOX System |
| 805 | Storable Bipropellant System |
| 806 | Solar Electric Propulsion (SEP) System |
| 807 | Nuclear Electric Propulsion (NEP) System |
| 810 | Non-Cryogenic Propellants Propulsion Technologies |
| 811-817 | Results |
| 820 | Fits into Commercial Lift Vehicle (CLV) Farings with Room for Payloads Propulsion Technologies |
| 821-827 | Results |
| 830 | Green Propellant Propulsion Technologies |
| 831-837 | Results |
| 840 | Rapid and Low Gravity-Loss Orbital Maneuvers Propulsion Technologies |
| 841-847 | Results |
| 850 | Single Fluid Possibility Propulsion Technologies |
| 860 | Propulsion Technologies |

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The term “coupled” as used herein refers to any logical or physical connection. Unless described otherwise, coupled elements or devices are not necessarily directly connected to one another and may be separated by intermediate components, elements, etc. The term “fluid communication” as used herein means that a substance, such as a liquid or a gas, can flow. In the examples herein, the combined moderator-propellant 102 is typically the substance. In some examples, during fluid communication the substance can flow between two or more chambers, channels, containers, tanks, or vessels such that when the substance settles, the substance balances out to the same level or pressure in all of the chambers, channels, containers, tanks, and vessels in fluid communication, regardless of the shape and volume of the chambers, channels, containers, tanks, and vessels.

Unless otherwise stated, any and all measurements, values, ratings, positions, magnitudes, sizes, angles, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as ± 5% or as much as ± 10% from the stated amount. The term “approximately” or “substantially” means that the parameter value or the like varies up to ± 10% from the stated amount.

The orientations of the nuclear thermal propulsion (NTP) system 100, nuclear reactor 107, nuclear reactor core 101, associated components, and/or any NTP system 100 incorporating the nuclear reactor core 101, fuel assemblies 204A-N, control drums 220A-F, such as shown in any of the drawings, are given by way of example only, for illustration and discussion purposes. In operation for a particular NTP system 100, the components may be oriented in any other direction suitable to the particular application of the NTP system 100, for example upright, sideways, or any other orientation. Also, to the extent used herein, any directional term, such as lateral, longitudinal, up, down, upper, lower, top, bottom, and side, are used by way of example only, and are not limiting as to direction or orientation of any NTP system 100 or component of the NTP system 100 constructed as otherwise described herein.

The various examples disclosed herein relate to combined moderator-propellant technologies that increase the mass efficiency and decrease the size (e.g., form factor) of a nuclear thermal propulsion (NTP) system 100 to improve the overall performance during operation. By combining the roles of moderator and propellant into a single fluid with a unified flow path, significant mass savings can be achieved within a lift vehicle implementing an NTP system 100. Utilizing propellant as a moderator allows for some or all of the moderator in the NTP system 100 to be ultimately used as propellant. Allowing the moderator to eventually be used as propellant gives the moderator a dual purpose, and obviates the need to add both a separate moderator (e.g., solid moderator blocks, such as graphite) and a separate propellant (e.g., hydrogen). Additionally, the NTP system does not require a separate tank for propellant. All of a combined-moderator propellant 102 can be stored within a pressure vessel 260 of the NTP system 100, and act as a moderator for the nuclear reactor 107 until expelled as propellant. The mass savings are substantial. An NTP system 100 utilizing combined moderator-propellant technologies potentially reduces the payload mass of the lift vehicle by as much or more than the weight of separate moderator and the tank of the separate propellant used in a conventional NTP-based lift vehicle.

The design paradigm of replacing elements of the nuclear reactor core 101 with the combined moderator-propellant 102 can be expanded further. In additional examples, not only are solid moderator blocks replaced with a moderator region 113 filled with liquid propellant acting as a moderator (the combined moderator-propellant 102), but control drums 220A-F of the nuclear reactor core 101 can be hollowed out (e.g., to form a cavity) and filled with combined moderator-propellant. This combined moderator-propellant 102 may need to be pressurized beyond the pressure within the moderator region 113 in order to allow the control drums 220A-F to reflect neutrons back into the nuclear reactor core 101.

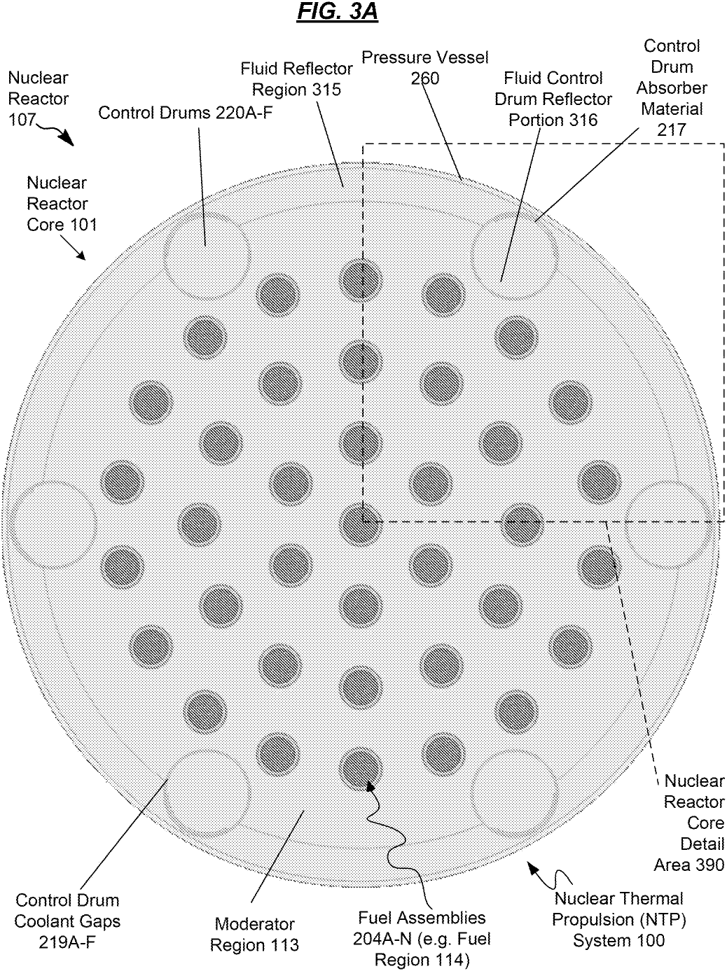

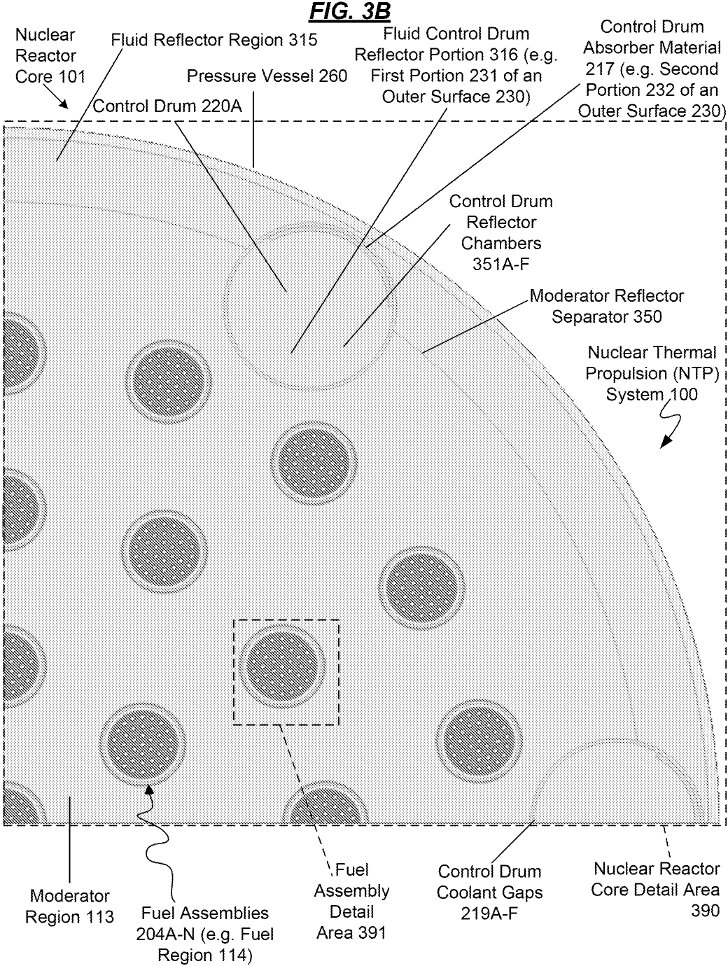

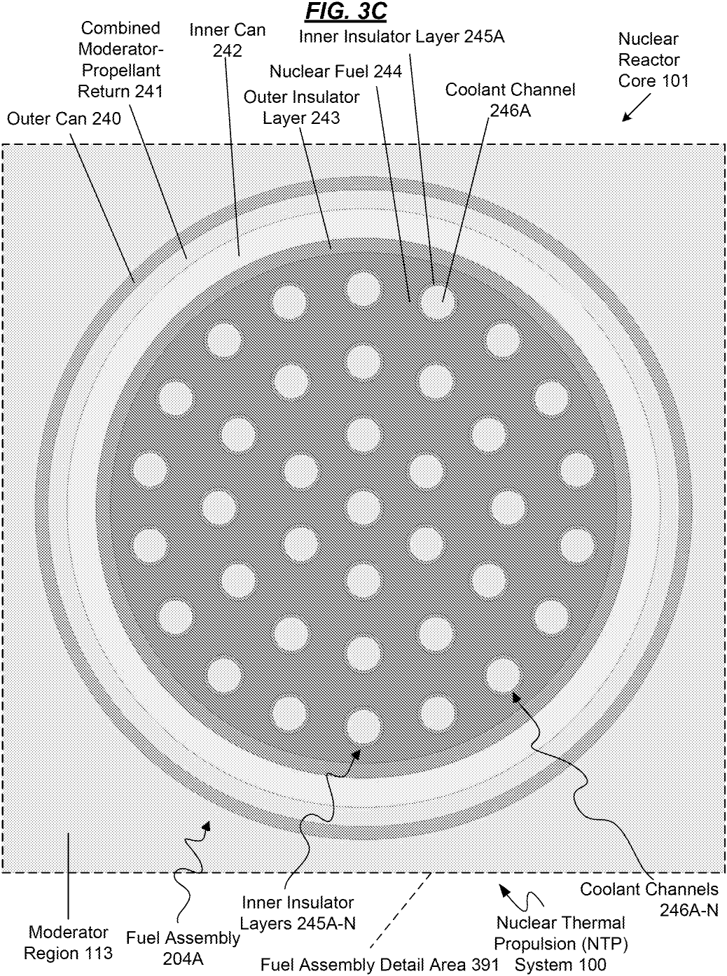

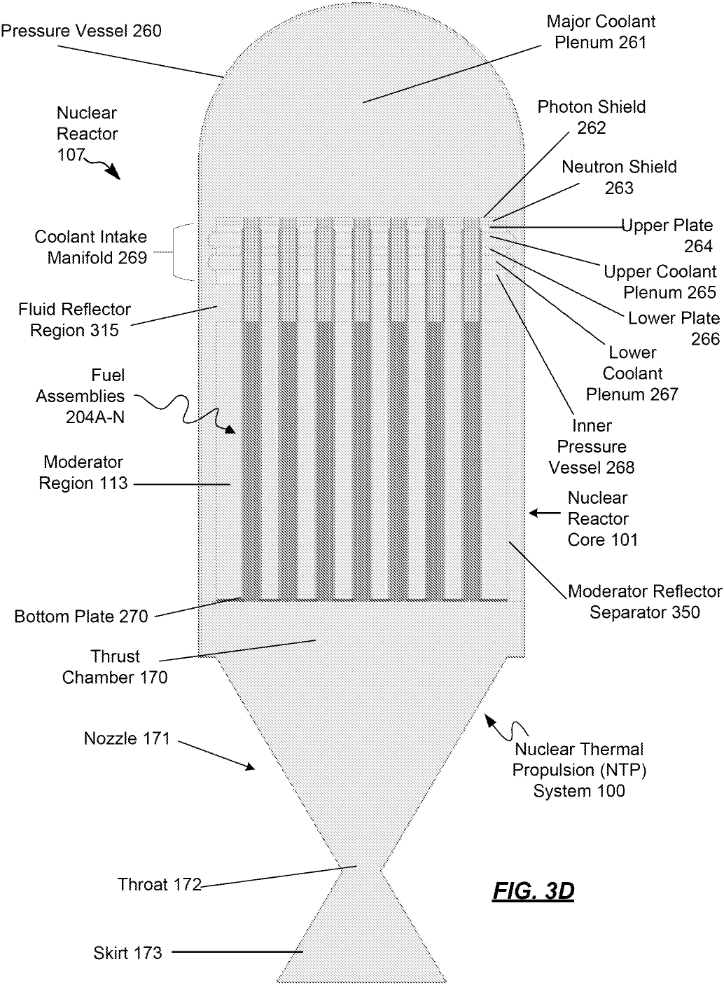

Additionally, solid reflector block(s) that form a solid reflector region 215 at the periphery of the nuclear reactor core 101 can also be replaced with a fluid reflector region 315, filled with combined moderator-propellant 102. This combined moderator-propellant 102 may also need to be pressurized beyond the pressure within the moderator region 113 in order to allow the fluid reflector region 315 to reflect neutrons back into the nuclear reactor core 101. The mass savings of replacing either the solid control drum reflection portion 216 of the control drums 220A-F, the solid reflector block(s) in the solid reflector region 215, or both with a fluid that can ultimately be used as propellant is substantial. Very generally, when looking from above (as in FIG. 3A) the nuclear reactor core 101 includes fuel assemblies 204A-N, thin dividing walls formed of metal alloys, and a small amount of neutron poison in the control drums. The rest of the nuclear reactor core 101 is generally combined-moderator propellant 102, which can ultimately be used to propel the lift vehicle utilizing the NTP system 100 through the atmosphere and space. Almost all of the nuclear reactor core 101 by volume performs two jobs: increasing, decreasing, and maintaining the temperature of the nuclear reactor core 101 in order to heat and expel propellant, as well as being that propellant to be expelled itself. The fuel assemblies 204A-N use up almost every part of the nuclear reactor core 101 to efficiently propel a lift vehicle forward, which improves mass efficiency and provides a smaller form factor of a nuclear reactor core 107 that includes the nuclear reactor core 101.

Reference now is made in detail to the examples illustrated in the accompanying drawings and discussed below.

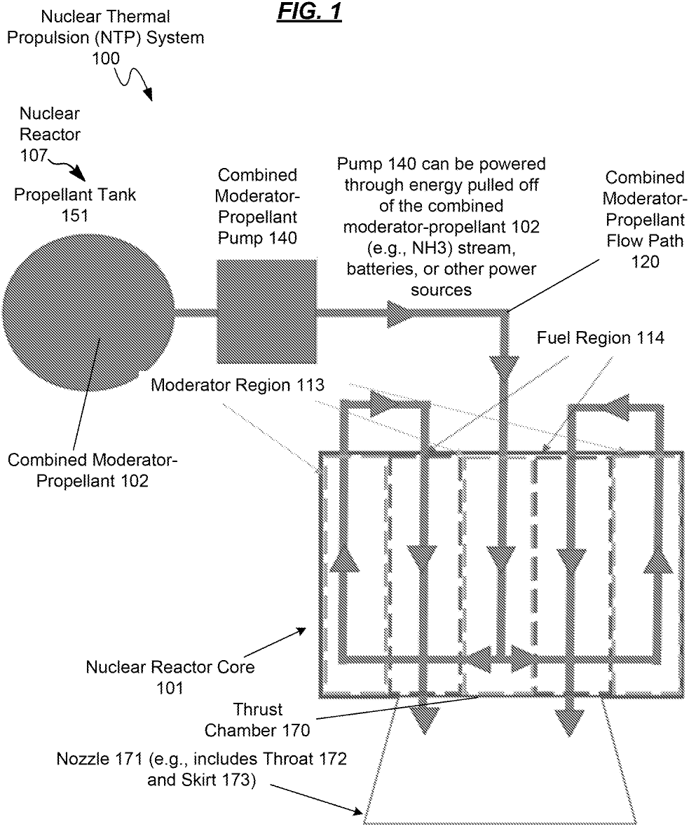

FIG. 1 is a notional flow diagram of a nuclear thermal propulsion system 100 that depicts a nuclear reactor 107 showing a combined moderator-propellant 102 flowing through a nuclear reactor core 101 (including a moderator region 113 and a fuel region 114), a combined moderator-propellant pump 140, a propellant tank 151, and other components of the NTP system 100. Generally described, the nuclear reactor 107 includes the nuclear reactor core 101, in which a controlled nuclear chain reaction occurs, and energy is released. The combined moderator-propellant 102 can be ammonia-based (NH3).

In the example, the NTP system 100 is a type of nuclear reactor 107 that operates on the principle of an expansion cycle, which pumps a combined moderator-propellant 102, such as ammonia (NH3), through a combined moderator-propellant flow path 120. The expansion cycle is driven by a combined moderator-propellant pump 140 or turbopump assembly (TPA). The combined moderator-propellant pump 140, or pumps and turbines in a TPA, move the combined moderator-propellant 102 through the combined moderator-propellant flow path 120 and the combined moderator-propellant 102 becomes superheated in the nuclear reactor core 101 and expands to a gas, e.g., for thrust or power generation.

In an alternative example, the nuclear reactor system that utilizes the combined moderator-propellant 102 can also be a terrestrial power system, such as a nuclear electric propulsion (NEP) system for fission surface power (FSP) system. NEP powers electric thrusters such as a Hall-effect thruster for robotic and human spacecraft. FSP provides power for planetary bodies such as the moon and Mars. In the NEP and FSP power applications, the nuclear reactor system enabled with combined moderator-propellant 102 technologies heats the working fluid (e.g., ammonia) through a power conversion system (e.g., Brayton) to produce electricity. Moreover, in the NEP and FSP power applications, the nuclear reactor system does not include a propellant, but rather includes the working fluid that passes through a reactor inlet when producing power. In the NEP and FSP power applications, the combined moderator-propellant 102 can be cooled via the reactor inlet working fluid (e.g., the flow coming out of a recuperator) before the working fluid passes through the fuel assemblies 204A-N. In NEP or FSP applications, a nuclear reactor system 100 may include a turbojet (e.g., a turbine and a compressor), instead of a turbopump assembly.

The NTP system 100 uses the nuclear reactor core 101, such as a compact fission reactor core that includes nuclear fuel, to generate many megawatts of thermal power (MWt) required to heat a combined moderator-propellant 102 to high exhaust temperatures for rocket thrust. The nuclear reactor core 101 provides thermal energy to drive the combined moderator-propellant pump 140. Operating the NTP system 100 during its various phases (startup, full thrust, and shutdown) is carried out by controlling the combined moderator-propellant 102 that is supplied via the combined moderator-propellant pump 140, to reach a desired reactor power level of the nuclear reactor core 101.

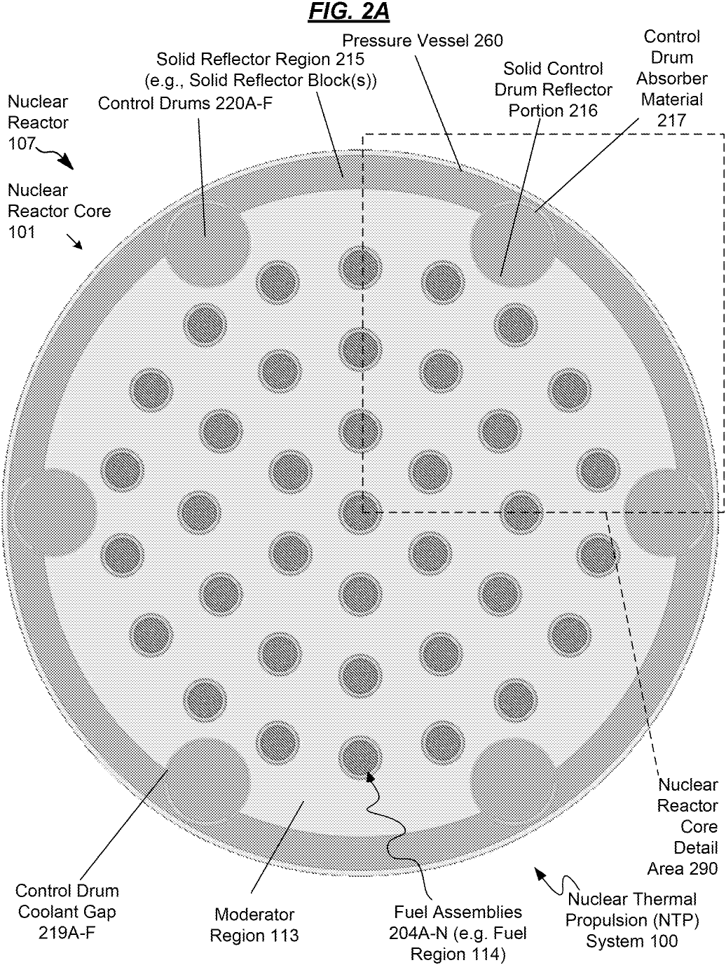

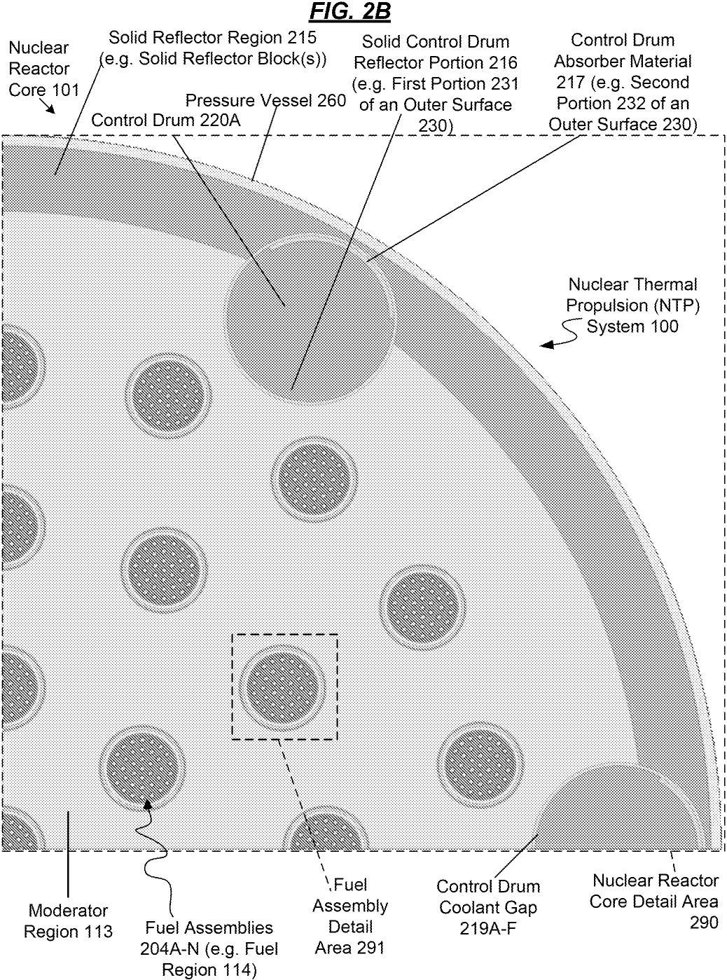

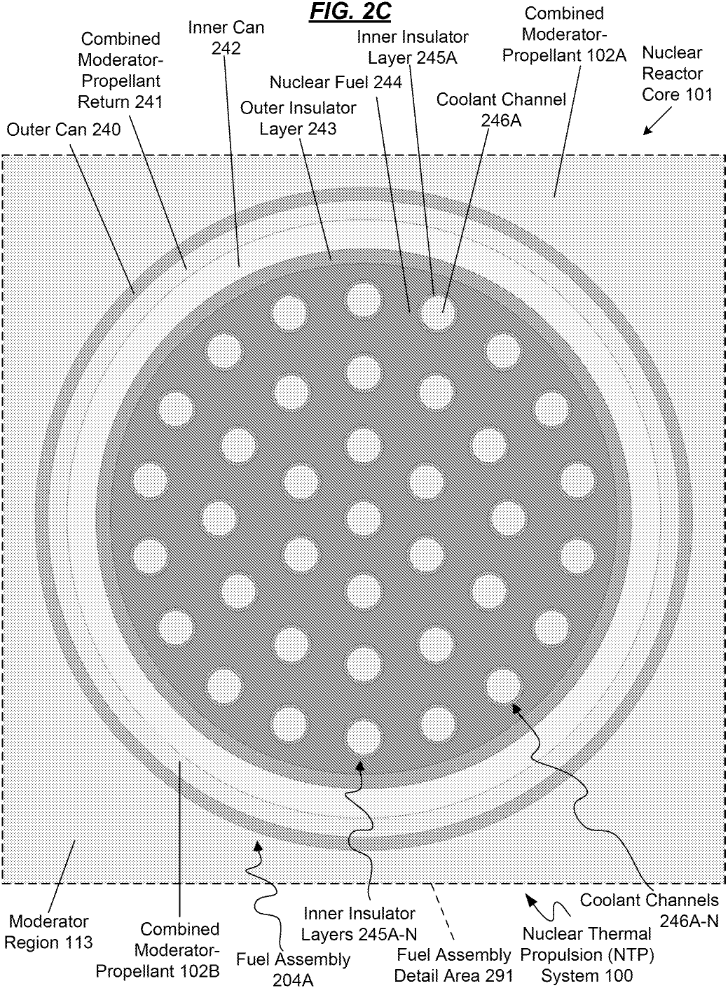

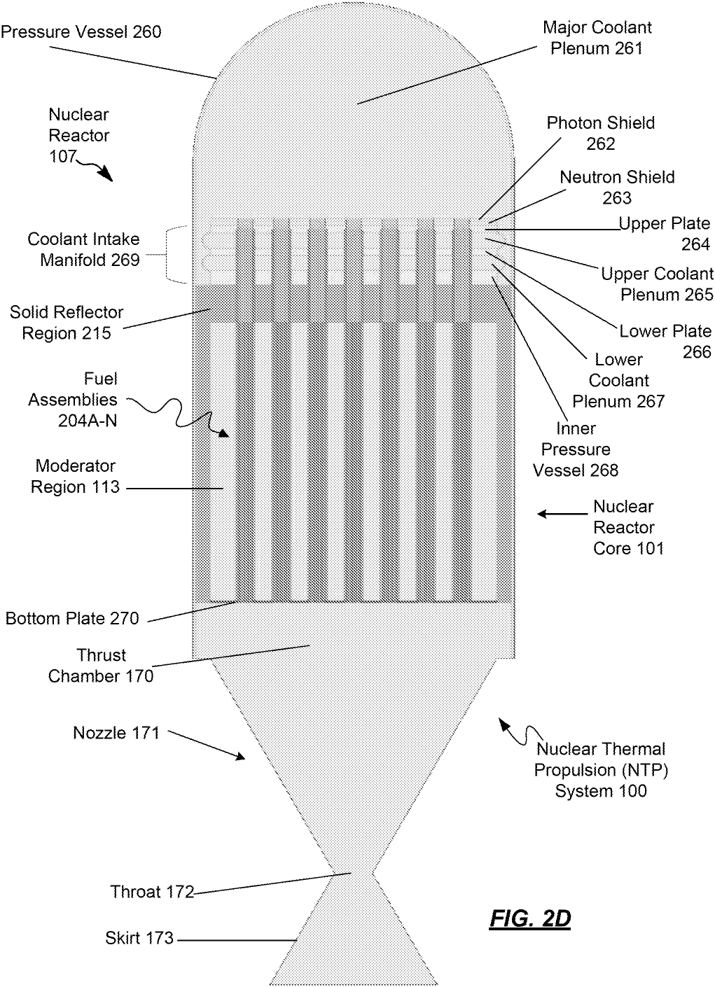

In FIG. 1, the combined moderator-propellant pump 140 is supplied with combined moderator-propellant 102 from a propellant tank 151 that is notional. As FIG. 1 is a notional diagram, the purpose is to illustrate the functional flow of the combined moderator-propellant 102 via a combined moderator-propellant flow path 120. In the designs shown in FIGS. 2A-D and 3A-D, the propellant tank 151 can be implemented within the moderator region 113, a major coolant plenum 261 of FIGS. 2D and 3D, as well as within the control drums 220A-F and/or solid reflector region 215 of FIGS. 3A-B.

The combined moderator-propellant pump 140 includes one or more sub-pumps. These sub-pumps can be dispersed anywhere along the combined moderator-propellant flow path 120 to increase, decrease, or stop the flow of combined moderator-propellant 102 along the combined moderator-propellant flow path 120.

The combined moderator-propellant pump 140 transfers combined moderator-propellant 102 from the propellant tank 151 through the nuclear reactor core 101 along the combined moderator-propellant flow path 120. The combined moderator-propellant flow path 120 first flows the combined moderator propellant 102 through the moderator region 113.

The combined moderator-propellant 102 is stored as a liquid in the propellant tank 151 of the NTP system 100 propulsion stage. Then the combined moderator-propellant 102 is pressurized by a combined moderator-propellant pump 140, circulated though the moderator region 113 of the nuclear reactor core 101, and then circulated through the nuclear fuel region 114 of the nuclear reactor core 101, finally leaving the nuclear reactor core 101 as propellant. This approach removes the need and mass associated with a separate solid moderator, such as graphite or zirconium hydride (ZrH).

The moderator region 113 thermalizes fast neutrons resulting from nuclear fission events and is designed to generally decrease the speed of fast neutrons emitted by fuel assemblies 204A-N (see FIGS. 2A-D and 3A-D) travelling within the moderator region 113, thereby increasing the reactivity and efficiency of the nuclear reactor core 101. In this example, the moderator region 113 does not include traditional solid blocks of moderator material, but rather is filled with combined moderator-propellant 102 flowed from the combined moderator-propellant pump 140 along the combined moderator-propellant flow path 120. While within the moderator region 113, the combined moderator-propellant 102 is primarily acting in the role of a moderator. Using the combined moderator-propellant 102 removes the solid moderator mass component from the NTP system 100, and can advantageously enable a more compact and lightweight NTP system 100. In the example-combined moderator-propellant 102, the ammonia-based (NH₃) moderator is also propellant. Hence, the moderator can also be used for thrust and does not add additional mass to the NTP system 100. To restate this: the ammonia moderator is not inert mass within the NTP system 100 utilizing combined moderator propellant 100.

The combined moderator-propellant 102 is initially heated while within the moderator region 113, as compared to the propellant tank 151. This initial heating will allow the fuel region 114 to overcome a smaller temperature differential between the temperature of the combined moderator-propellant 102 in the propellant tank 151. The initially heated combined moderator-propellant 102 then flows through the fuel region 114 where the heated combined moderator-propellant 102 is superheated. Finally, the combined moderator-propellant 102 ultimately flows to a chamber 170 (e.g., a thrust chamber, such as a rocket chamber).

The combined moderator-propellant flow path 120 may pass through the moderator region 113 multiple times, for example through a combined moderator-propellant return 241 in FIG. 2C surrounding the fuel assemblies 204A-N; or alternatively through control drum coolant gaps 219A-F in FIG. 2B. The moderator region 113 however does not necessarily have a “directional” flow as depicted, meaning that combined moderator-propellant 102 may enter from the top of the moderator region 113, and exit out different openings or channels in the moderator region 113 in order to pass into the fuel region 114.

The initially heated combined moderator-propellant fuel path 102 then exits the moderator region 113 and enters the fuel region 114. When within the fuel region 114, the combined moderator-propellant 102 is primarily acting in the role of a propellant. The fuel region 114 includes the fuel assemblies 204A-N, which superheat the combined moderator-propellant 102 passing through the fuel region 114 along the combined moderator-propellant flow path 120 toward the thrust chamber 170.

Selective fluid communication of the combined moderator-propellant 102 in the combined moderator-propellant flow path 120 can be achieved with a valve and an actuator. Each valve can be electronically or mechanically operated by one or more actuators. The valves can be spring loaded to one position and electrically actuated to another position to adjust valve position and hence propellant density via electric signals from a computer. Mechanically activated valves can be advantageous for control of liquid propellant flows; whereas, electrically activated valves can be used for lighter loads, such as gaseous propellant flows. For example, each valve facilitating selective communication of combined moderator-propellant 102 is controlled by an actuator via mechanical energy, such as hydraulic fluid pressure, pneumatic pressure, thermal energy, or magnetic energy. The actuator can be controlled by external mechanical energy or electronic circuitry, for example, the actuator can be driven by electric current control signals from a computer, microcontroller, digital or analog circuit, etc. The actuator can be a solenoid, variable displacement pump, electric motor, hydraulic cylinder, pneumatic, screw jack, ball screw, hoist, rack and pinion, wheel and axle, chain drive, servomechanism, stepper motor, piezoelectric, shape-memory, electroactive polymer, thermal bimorph, etc. In one example, the actuator is an internally piloted solenoid valve that acts directly on the valve. The valve and the actuator can collectively form a solenoid valve or a servovalve, such as an electrohydraulic servo valve. It may be advantageous for each valve to include multiple actuators, such as a solenoid driven by conveyed electric control signals that, in turn, acts on other actuators, such as a larger rack and pinion actuator, that in turns controls a pneumatically actuated valve, for example.

Using the combined moderator-propellant 102 removes the difficulties associated with the hydrogen (H₂) propellant normally used in NTP systems. Hydrogen propellant as used in many NTP concepts must be stored at cryogenic temperatures (< 30 Kelvin (K)) and is a very low-density propellant. As such, the mass for tanks to store H₂ and equipment for keeping H₂ cryogenic have a large mass. As a particular example, in order to store 10,000 kg of propellant, when using cryogenic H₂, the propellant tank would weigh an additional 8,621 kilograms (kg). As an alternative, 10,000 kg pressurized NH₃ would only have a propellant tank 151 weighing an additional 780 kg. This results in a 600 kilogram per cubic meter (kg/m³) propellant density for NH₃, as opposed to a 71 kg/m³ propellant density for cryogenic H₂. Additionally, cryogenic H₂ is only a liquid up to -253° C., as opposed to NH₃ which is liquid up to 47° C. (C) at 2 megapascals (MPa). Liquids are more suited to acting as a moderator than gases, and so H₂ is unlikely to serve well as a combined moderator-propellant 102.

The superheated combined moderator-propellant 102 then moves into the thrust chamber 170, where the superheated combined moderator-propellant 102 is pressurized and forced through a nozzle 171 that includes a throat 172 and a skirt 173. The superheated combined moderator-propellant 102 is pressurized and forced through the throat 171 of the nozzle 171 and then the skirt 173 of the nozzle 171, thereby generating propulsion of the NTP system 100.

The combined moderator-propellant pump 140 is a propellant pump with two main components: a rotodynamic pump and a driving gas turbine. The rotodynamic pump and driving gas turbine can be mounted on the same shaft, or sometimes geared together. The combined moderator-propellant pump 140 produces a high-pressure fluid of combined moderator-propellant 102 for feeding the nuclear reactor core 101, cooling components of the NTP system 100, and moderating the amount of neutron fluence within the nuclear reactor core 101.

When the combined moderator-propellant 102 is superheated to a gas in the fuel region 114 of the nuclear reactor core 101, the combined moderator-propellant 102 accelerates and is exhausted from the thrust chamber 170 for expansion in the nozzle 171. The thermal expansion of the combined moderator-propellant 102 through the throat 172 and the skirt 173 of the nozzle 171 provides thrust. Some of the superheated combined-moderator propellant 102 can be used to turn a driving gas turbine of the combined moderator-propellant pump 140 to drive the rotodynamic pump. Of note, some of the superheated combined moderator-propellant 102 may be returned, for example bled from the nuclear reactor core 101 via a bypass, to turn the driving gas turbine of the combined moderator-propellant pump 140 to drive the rotodynamic pump. Subsequently, the expansion cycle repeats.

The generated thrust propels a vehicle that houses, is formed integrally with, connects, or attaches to the NTP system 100, such as a rocket, drone, unmanned air vehicle (UAV), aircraft, spacecraft, missile, etc. The vehicle can include various control nozzles for steering and other components. In the depicted example, the NTP system 100 with the nuclear reactor core 101 is utilized in a space environment. For example, the NTP system 100 that includes the combined moderator-propellant 102 can be a nuclear thermal rocket reactor, nuclear electric propulsion reactor, Martian surface reactor, or lunar surface reactor. In addition, the NTP system 100 can be used in the propulsion of submarines or ships.

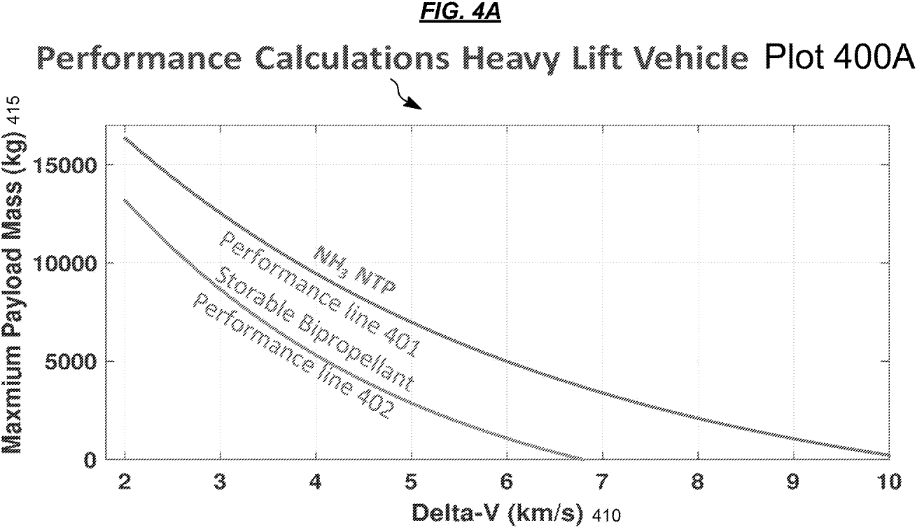

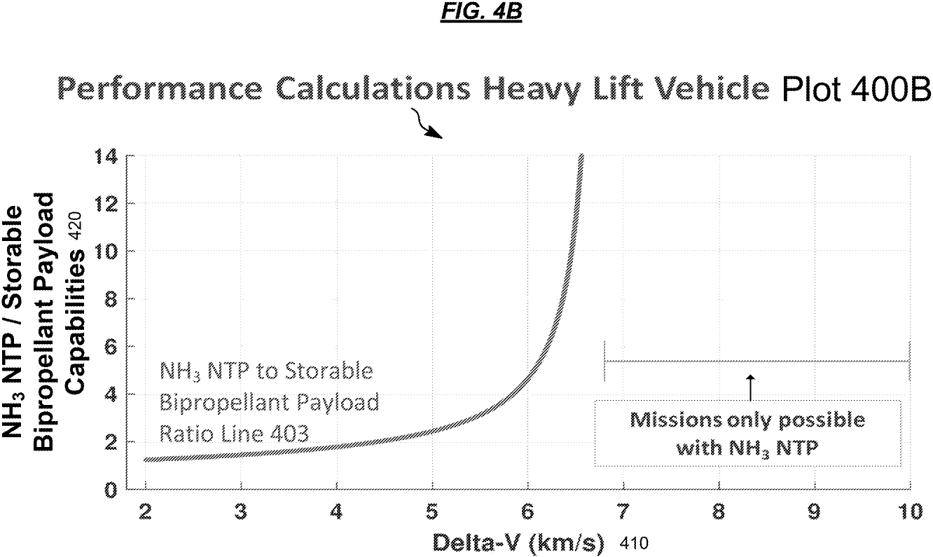

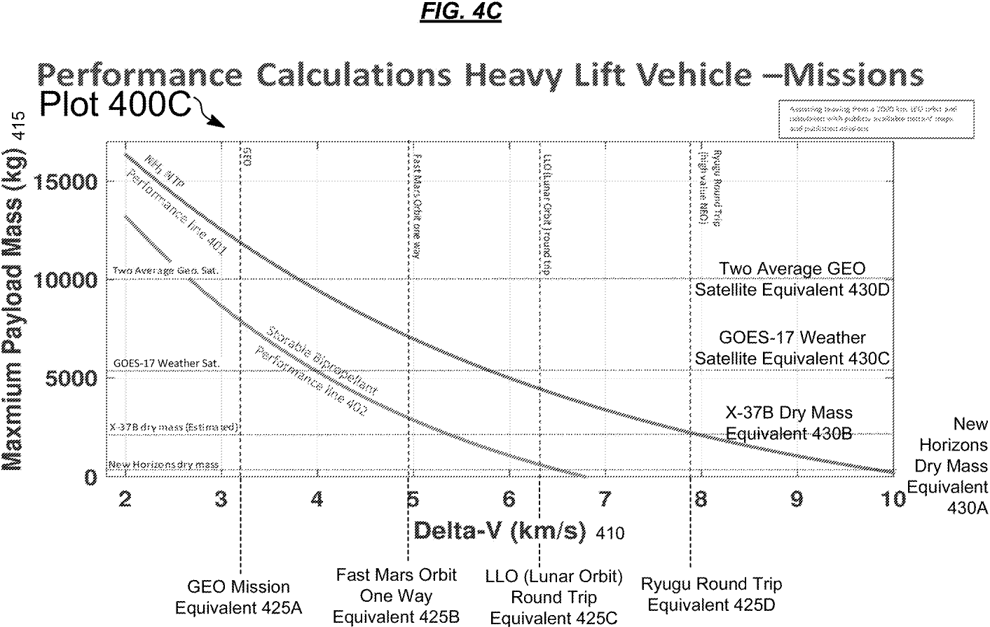

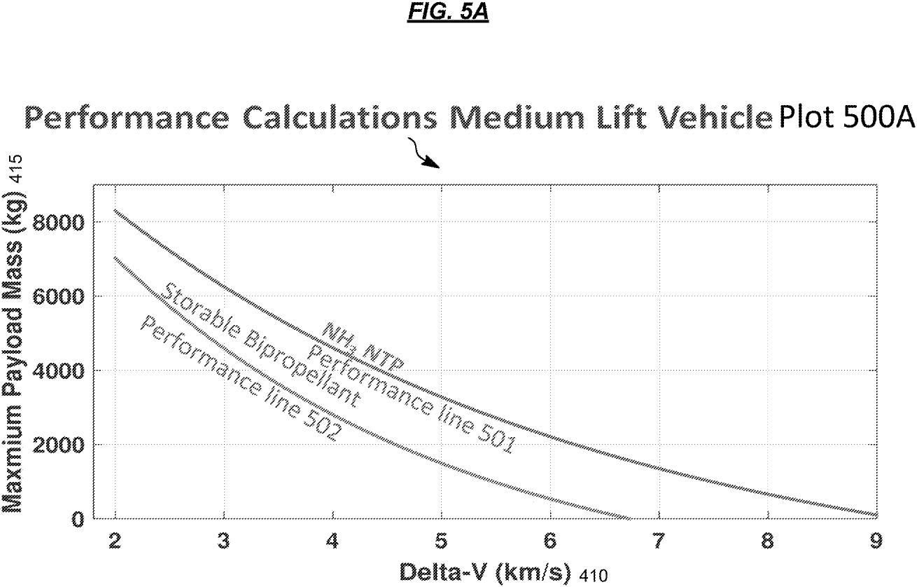

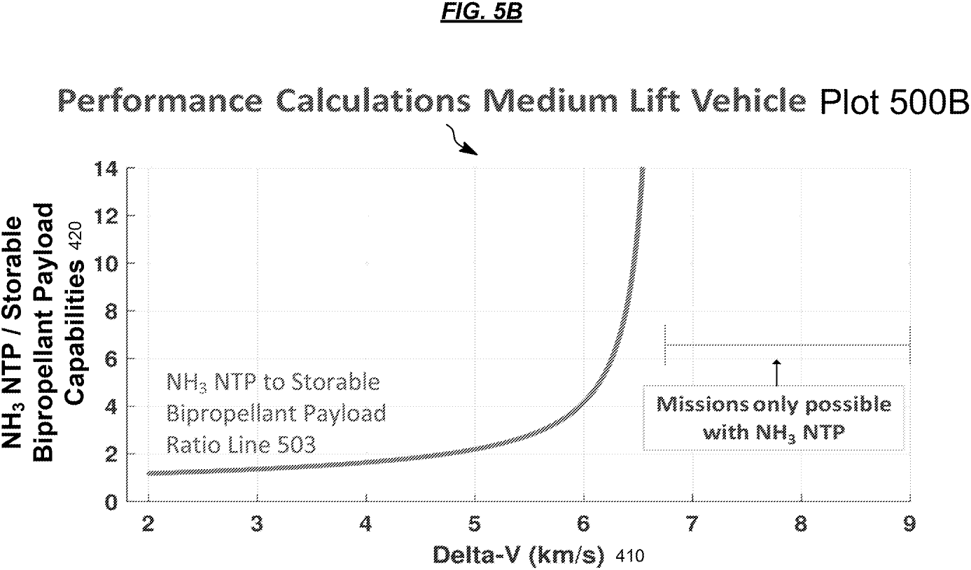

FIG. 2A is a transverse cross-section illustration of a first variation of the combined moderator-propellant NTP nuclear reactor core 101 of FIG. 1. The NTP system 100 includes solid beryllium (Be) control drums and the nuclear reactor core 101 includes a solid beryllium reflector region 215. As shown, the nuclear reactor core 101 includes an array of fuel assemblies 204A-N. The fuel assemblies 204A-N are generally distributed within rings centered around the nuclear reactor core 101. Inner rings of fuel assemblies 204A-N are generally hexagonal, whereas outer rings of fuel assemblies 204A-N are generally circular. The number of fuel assemblies 204A-N can be adjusted. The fuel assemblies 204A-N can be distributed like the fuel openings 131A-M, 132A-M described in the various models, studies, and designs in FIGS. 4-5 and the associated text of International Application No. PCT/US2021/014858, filed on Jan. 25, 2021, titled “Skewed-Pin (SPIN) Moderator Blocks for Nuclear Reactor,” which published as International Publication No. WO 2021/151055 on Jul. 29, 2021, the entirety of which is incorporated by reference herein.

A solid reflector region 215 surrounds the array of fuel assemblies 204A-N and the moderator region 113 of the nuclear reactor core 101. The solid reflector region 215 redirects free neutrons back toward the nuclear reactor core 101, increasing the number of fissile reactions, energy production, and nuclear reactor core 101 operating temperature.

A plurality of circumferential control drums 220A-F may surround the array of fuel assemblies 204A-N to change reactivity of the nuclear reactor core 101 by rotating the control drums 220A-F. Multiple control drums 220A-F may be positioned in an area of the solid reflector region 215 to regulate the neutron population and reactor power level during operation. The solid reflector region 215 can include one more sold reflector block(s).

A control drum 220A includes a solid control drum reflector portion 216, which in this example is generally formed of a material with a high elastic scattering neutron cross section. When the solid control drum reflector portion 216 faces inwards towards the nuclear reactor core 101, the neutron flux increases, which increases the reactivity and operating temperature of the nuclear reactor core 101. The control drum 220A also includes a control drum absorber material 217, which can be formed of a neutron poison. Neutron poisons are isotopes or molecules with a high absorption neutron cross section particularly suited to absorbing free neutrons. When the control drum absorber material 217 faces inwards towards the nuclear reactor core 101, the neutron flux decreases, which decreases the reactivity and operating temperature of the nuclear reactor core 101.

The control drums 220A-F can be implemented like any control drums 115A-U described in FIGS. 1A-6B and the associated text of International Application No. PCT/US2020/054189 to Ultra Safe Nuclear Corporation of Seattle, Washington, filed Oct. 4, 2020, titled “Automatic Shutdown Controller for Nuclear Reactor System with Control Drums,” which published as International Publication No. WO 2021/067902 on Apr. 8, 2021, the entirety of which is incorporated by reference herein. The control drums 220A-F can be driven by actuators 120A-Z described in FIGS. 1A-8 and the associated text of International Application No. PCT/US2021/XXXXXX to Ultra Safe Nuclear Corporation of Seattle, Washington, filed Aug. 17, 2021, titled “Control Drum Controller for Nuclear Reactor System,” the entirety of which is incorporated by reference herein.

Typically, the control drums 220A-F and fuel assemblies 204A-N are the same length; however, it should be understood that the lengths can differ depending on the implementation. A portion of the nuclear reactor core 101 is boxed and labeled as element 290 and this nuclear reactor core detail area 290 is magnified in FIG. 2B.

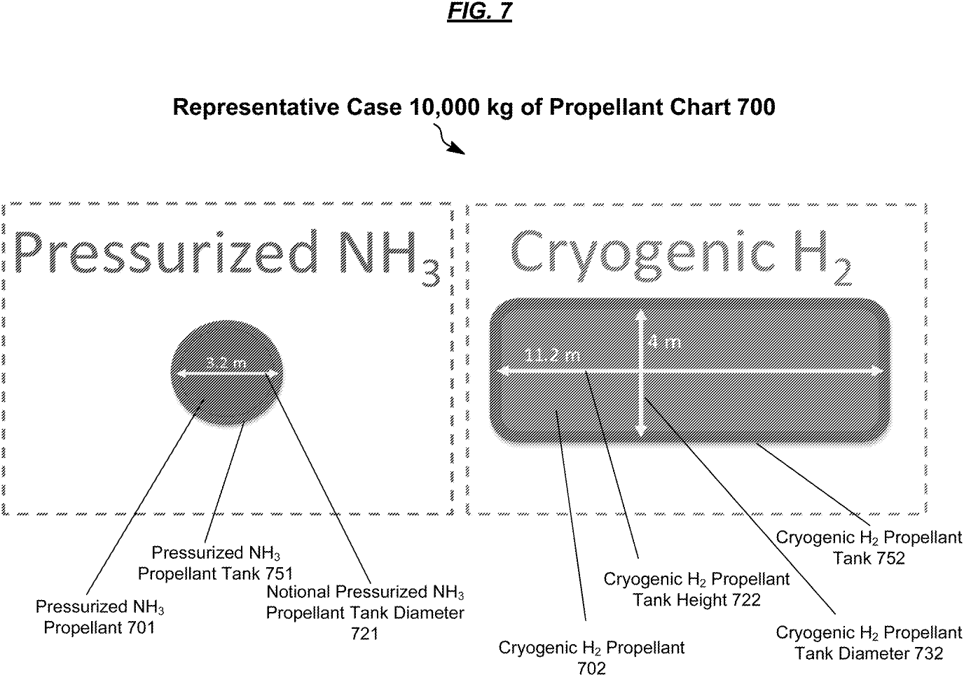

In a first example, the fuel assemblies 204A-N can be implemented like the fuel elements 310A-N described in FIGS. 3 and 7 and the associated text of U.S. Pat. No. 10,643,754 to Ultra Safe Nuclear Corporation of Seattle, Washington, issued May 5, 2020, titled “Passive Reactivity Control of Nuclear Thermal Propulsion Reactors” the entirety of which is incorporated by reference herein. In a second example, the fuel assemblies 204A-N can be implemented like the fuel elements 102A-N described in FIG. 2C and the associated text of U.S. Pat. Pub. No. 2020/0027587 to Ultra Safe Nuclear Corporation of Seattle, Washington, published Jan. 23, 2020, titled “Composite Moderator for Nuclear Reactor Systems,” the entirety of which is incorporated by reference herein.

NTP system 100 includes a solid reflector region 215 (e.g., an outer reflector region) located inside the pressure vessel 260. Solid reflector region 215 includes a plurality of reflector blocks laterally surrounding the plurality of fuel assemblies 204A-N and the moderator region 113.

NTP system 100 includes the nuclear reactor core 101, in which a controlled nuclear chain reaction occurs, and energy is released. The neutron chain reaction in the nuclear reactor core 101 is critical – a single neutron from each fission nucleus results in fission of another nucleus – the chain reaction must be controlled. By sustaining controlled nuclear fission, the NTP system 100 produces heat energy. In an example implementation, the nuclear reactor system 100 is implemented as a gas-cooled high temperature nuclear reactor core 101. However, the combined moderator-propellant 102 can be included in a large utility scale nuclear reactor, heat pipe nuclear reactor, molten-salt-cooled nuclear reactor, fuel-in-salt nuclear reactor, or a sodium-cooled fast nuclear reactor. For example, combined moderator-propellant 102 can be included in an NTP system 100, such as a gas-cooled graphite-moderated nuclear reactor, a fluoride salt-cooled high-temperature nuclear reactor with a higher thermal neutron flux than the gas-cooled graphite-moderated nuclear reactor, or a sodium fast nuclear reactor with a faster neutron flux than the gas-cooled graphite-moderated nuclear reactor.

As noted above, the NTP system 100 can also be implemented instead as a nuclear power plant in a terrestrial land application, e.g., for providing nuclear power (e.g., thermal and/or electrical power) for remote region applications including outer space, celestial bodies, planetary bodies, and remotes regions on Earth. For example, the NTP system 100 with combined moderator-propellant 102 is utilized in a space nuclear reactor 107 for electrical power production on a planetary surface. The nuclear reactor system 100 with the combined moderator-propellant 102 can be a small commercial fission power system for near term space operations, lunar landers, or a commercial fission power system for high-power spacecraft and large-scale surface operations, such as in-situ resource utilization.

The NTP system 100 can be designed to, for example, travel into space, land on a planetary body, perform extended operations, and return to space. In such an example, the NTP system 100 would utilize the combined moderator-propellant 102 in the nuclear reactor core 101 to traverse space to the planetary body. Once affixed to the planetary body, the NTP system 100 can instead use the combined moderator-propellant 102 as a moderator and a coolant, looping the combined moderator-propellant 102 through the fuel region 114, and bleeding off heat to power other instrumentation, much like how the combined moderator-propellant pump 140 can operate based on extra heat from the combined moderator-propellant 102. Once the operations on the planetary body are complete, the NTP system 100 can return to using the combined moderator-propellant 102 as a moderator and a propellant, returning the NTP system 100 into space.

Therefore, the NTP system 100 can also be a terrestrial power system, such as a nuclear electric propulsion (NEP) system for fission surface power (FSP) system. NEP powers electric thrusters such as a Hall-effect thruster for robotic and human spacecraft. FSP provides power for planetary bodies such as the moon and Mars. In the NEP and FSP power applications, the NTP system 100 heats the combined moderator-propellant 102 through a power conversion system (e.g., Brayton) to produce electricity. Moreover, in the NEP and FSP power applications, the NTP system 100 does not necessarily utilize the combined moderator-propellant 102 as a propellant, but rather as a working fluid that passes through a reactor inlet when producing power. In the NEP and FSP power applications, the moderator region 113 is still filled with and can be cooled via the reactor inlet combined moderator-propellant 102 (e.g., the flow coming out of a recuperator) before the combined moderator-propellant 102 passes through the fuel assemblies 204A-N.

As shown in FIG. 2A, in the NTP system 100, the nuclear reactor core 101 can include a plurality of control drums 220A-F and a solid reflector region 215. The control drums 220A-F may laterally surround the moderator region 113 and the fuel region 114 of nuclear assemblies 204A-N to change reactivity of the nuclear reactor core 101 by rotating the control drums 220A-F. As depicted, the control drums 220A-F reside on the perimeter or periphery of a pressure vessel 260 and are positioned circumferentially around the moderator region 113 and fuel assemblies 204A-N of the nuclear reactor core 101. Control drums 220A-F may be located in an area of the solid reflector region 215, e.g., an outer reflector region formed of reflector blocks immediately surrounding the nuclear reactor core 101, to selectively regulate the neutron population and reactor power level during operation. For example, the control drums 220A-F can be a cylindrical shape and formed of both a solid control drum reflector portion 216 (e.g., beryllium (Be), beryllium oxide (BeO), BeSiC, BeMgO, Al₂O₃, etc.) and a control drum absorber material 217.

The solid control drum reflector portion 216 and the control drum absorber material 217 can be on opposing sides of the cylindrical shape, e.g., portions of an outer circumference, of the control drums 220A-F. The solid control drum reflector portion 216 can include a reflector substrate shaped as a cylinder or a truncated portion thereof. The control drum absorber material 217 can include an absorber plate or an absorber coating. The absorber plate or the absorber coating are disposed on the reflector substrate to form the cylindrical shape of each of the control drums 220A-F. For example, the absorber plate or the absorber coating covers the reflector substrate formed of the reflector material to form the control drums 220A-F. When the solid control drum reflector portion 216 is the truncated portion of the cylinder, the control drum absorber material 217 is a complimentary body shape to the truncated portion to form the cylindrical shape.

Control drums 220A-F can be formed of a continuous surface, e.g., rounded, aspherical, or spherical surfaces to form a cylinder or other conical surfaces to form a quadric surface, such as a hyperboloid, cone, ellipsoid, paraboloid, etc. Alternatively or additionally, the control drums 220A-F can be formed of a plurality of discontinuous surfaces (e.g., to form a cuboid or other polyhedron, such as a hexagonal prism). As used herein, “discontinuous” means that the surfaces in aggregate do not form a continuous outer surface 165 that is round (e.g., circular or oval) perimeter of the control drums 220A-F. In FIGS. 2A-B, the outer surface shown is a rounded continuous surface.

Rotating the depicted cylindrical-shaped control drums 220A-F changes proximity of the control drum absorber material 217 (e.g., boron carbide, B₄C) of the control drums 220A-F to the nuclear reactor core 101 to alter the amount of neutron reflection. When the solid control drum reflector portion 216 is inwards facing towards the nuclear reactor core 101 and the control drum absorber material 217 is outwards facing, neutrons are scattered back (reflected) into the nuclear reactor core 101 to cause more fissions and increase reactivity of the nuclear reactor core 101. When the control drum absorber material 217 is inwards facing towards the nuclear reactor core 101 and the solid control drum reflector portion 216 is outwards facing, neutrons are absorbed and further fissions are stopped to decrease reactivity of the nuclear reactor core 101.

The outer solid reflector region 215 can be filler elements disposed between outermost nuclear fuel assemblies 204A-N and the control drums 220A-F as well as around the control drums 220A-F. The solid reflector region 215 can be formed of a moderator that is disposed between the outermost fuel assemblies 204A-N and an optional barrel (e.g., formed of beryllium). The solid reflector region 215 can include hexagonal or partially hexagonal shaped filler elements and can be formed of a neutron moderator (e.g., beryllium oxide, BeO). Although not required, NTP system 100 can include the optional barrel (not shown) to surround the bundled collection that includes the moderator region 113, fuel region 114, of the nuclear reactor core 101, as well as the solid reflector region 215. As depicted, the control drums 220A-F reside on the perimeter of the pressure vessel 260 and can be interspersed or disposed within the solid reflector region 215, e.g., surround a subset of the filler elements (e.g., solid reflector blocks) forming the reflector 140.

Pressure vessel 260 can be formed of aluminum alloy, carbon-composite, titanium alloy, a radiation resilient SiC composite, nickel-based alloys (e.g., Inconel™ or Haynes™), or a combination thereof. Pressure vessel 260 and NTP system 100 can be comprised of other components, including cylinders, piping, and storage tanks that transfer the combined moderator-propellant 102 that flows through the moderator region 113, the combined moderator-propellant return 241 (see FIGS. 2C and 3C), or the coolant channels 246A-N (see FIGS. 2C and 3C. The combined moderator-propellant 102 can be a gas or a liquid, e.g., that transitions from a liquid to a gas state during a burn cycle of the nuclear reactor core 101 for thrust generation in the NTP system 100. Ammonia is the example combined moderator-propellant for the NTP system 100.

FIG. 2B is a detail area 290 illustration of the transverse cross-section of the combined moderator-propellant NTP nuclear reactor core 101 of FIG. 2A. In the nuclear reactor core detail area 290, it is easier to see elements such as the control drum absorber material 217. Additionally, the control drum coolant gaps 219A-F are more clearly visible. In a conventional control drum, a small gap is provided between the control drum and the object (e.g. the solid reflector region 215, moderator region 113, or both) in order to allow the control drum to turn. Typically, this small gap is filled with a non-burnable lubricant, or non-reactive ball bearings. However, in this NTP system 100, the control drums 220A-F each have a control drum coolant gap 219A-F. The control drum coolant gap 219A-F is filled with the combined moderator-propellant 102, and is in fluid communication or selective fluid communication with the combined moderator-propellant flow path 120. This means that, for example, once all of the reserve combined moderator-propellant 102 is expended, and the control drums 220A-F no longer need to reliably turn, the combined moderator-propellant 102 used as a lubricant in the control drum coolant gaps 219A-F can be utilized by the NTP system 100 as propellant, making the NTP system 100 more mass-efficient. One or more walls between the control drum coolant gaps 219A-F and the moderator region 113 can allow for the combined moderator-propellant 102 of the moderator region 113 to be kept at a separate pressure from the combined moderator-propellant 102 of the control drum coolant gaps 219A-F when the moderator region 113 is not in fluid communication with the control drum coolant gaps 219A-F.

In FIG. 2B, a portion of the nuclear reactor core 101 is boxed and labeled as a fuel assembly detail area 291, which is magnified in FIG. 2C. Hence, FIG. 2C is the fuel assembly detail area 291 illustration of a fuel assembly 204A of the combined moderator-propellant NTP nuclear reactor core 101 of FIG. 2A. In the fuel assembly detail area 291, it is easier to see the elements of a given fuel assembly 204A. First, the fuel assembly 204A includes an outer can 240 that surrounds the entire fuel assembly 204A. The outer can 240 separates the fuel assembly 204A from the moderator region 113. Within the outer can 240 is a combined moderator-propellant return 241. This combined moderator-propellant return 241 can be in the combined moderator-propellant flow path 120, between the moderator region 113 and the coolant channels 246A-N. Combined moderator-propellant 102 in the combined moderator-propellant return 241 may be absorbing heat to be bled off in order to power instrumentation or the combined moderator-propellant pump 140 or simply cooling the fuel assembly 204A. Combined moderator-propellant 102 in the combined moderator-propellant return 241 may also be absorb heat in the combined moderator-propellant return 241 before flowing into the coolant channels 246A-N, reducing the amount of heat the fuel assembly 204A has to impart upon the combined moderator-propellant 102 in order to superheat the combined moderator-propellant 102 before passing the combined moderator-propellant 102 to the thrust chamber 170.

The combined moderator-propellant return 241 is then internally bounded by the inner can 242. Both the outer can 240 and the inner can 242 can be non-radioactive metal alloys, and serve the purpose of separating different volumes, portions, or segments of the combined moderator-propellant 102A from interacting with other combined moderator-propellant 102B at a different stage on the combined moderator-propellant flow path 120. The combined moderator-propellant return 241 can also be selectively coupled with the coolant channels 246A-N in order to behave as a dual pass heat exchanger. Adjusting a density of the combined moderator propellant 102 in the combined moderator-propellant return 241 can control the reactivity of the nuclear reactor core 101.

Between the nuclear fuel 244 itself and the inner can 242 is an outer insulator layer 243. Additionally, within the nuclear fuel 244 are multiple coolant channels 246A-N, with inner insulator layers 245A-N between each coolant channel 246A-N and the nuclear fuel 244. The inner insulator layer 245A and outer insulator layer 243 are formed of a high-temperature thermal insulator material with low thermal conductivity. The high-temperature thermal insulator material can include low density carbides, metal-carbides, metal-oxides, or a combination thereof. More specifically, the high-temperature thermal insulator material includes low density SiC, stabilized zirconium oxide, aluminum oxide, low density ZrC, low density carbon, or a combination thereof.

The coolant channels 246A-N are in the combined moderator-propellant flow path 120, between the moderator region 113 and the thrust chamber 170. The nuclear fuel 244 superheats the combined moderator-propellant 102 within the coolant channels 246A-N, placing approximately all of the combined moderator-propellant 102 in a superheated gaseous state as it enters the thrust chamber 170.

Each of the fuel assemblies 204A-N includes a nuclear fuel 244. The nuclear fuel 244 includes a fuel compact comprised of coated fuel particles, such as tristructural-isotropic (TRISO) fuel particles embedded inside a high-temperature matrix. In some implementations, the nuclear fuel 244 includes a fuel compact comprised of bistructural-isotropic (BISO) fuel particles embedded inside the high-temperature matrix. In yet another implementation, the nuclear fuel 244 includes a fuel compact comprised of a variation of TRISO known as TRIZO fuel particles. A TRIZO fuel particle replaces the silicon carbide layers of the TRISO fuel particle with zirconium carbide (ZrC). Alternatively, the TRIZO fuel particle includes the typical coatings of a TRISO fuel particle and an additional thin ZrC layer coating around the fuel kernel, which is then surrounded by the typical coatings of the TRISO fuel particle. In a further implementation, the nuclear fuel 244 includes a fuel compact comprised of a variation of BISO known as UN BISO fuel particles. A UN BISO fuel particle includes a fuel kernel of uranium nitride (UN). The high-temperature matrix includes silicon carbide, zirconium carbide, titanium carbide, niobium carbide, tungsten, molybdenum, or a combination thereof. Each of the TRISO fuel particles can include a fuel kernel surrounded by a porous carbon buffer layer, an inner pyrolytic carbon layer, a binary carbide layer (e.g., ceramic layer of SiC or a refractory metal carbide layer), and an outer pyrolytic carbon layer. The refractory metal carbide layer of the TRISO fuel particles can include at least one of titanium carbide (TiC), zirconium carbide (ZrC), niobium carbide (NbC), tantalum carbide, hafnium carbide, ZrC—ZrB₂ composite, ZrC—ZrB₂—SiC composite, or a combination thereof. The high-temperature matrix can be formed of the same material as the binary carbide layer of the TRISO fuel particles.

A description of TRISO fuel particles dispersed in a silicon carbide matrix to form a cylindrical shaped nuclear fuel compact is provided in the following patents and publications of Ultra Safe Nuclear Corporation of Seattle, Washington: U.S. Pat. No. 9,299,464, issued Mar. 29, 2016, titled “Fully Ceramic Nuclear fuel and Related Methods”; U.S. Pat. No. 10,032,528, issued Jul. 24, 2018, titled “Fully Ceramic Micro-encapsulated (FCM) fuel for CANDUs and Other Reactors”; U.S. Pat. No. 10,109,378, issued Oct. 23, 2018, titled “Method for Fabrication of Fully Ceramic Microencapsulation Nuclear Fuel”; U.S. Pat. Nos. US 9,620,248, issued Apr. 11, 2017 and 10,475,543, issued Nov. 12, 2019, titled “Dispersion Ceramic Micro-encapsulated (DCM) Nuclear Fuel and Related Methods”; U.S. Pat. Pub. No. 2020/0027587, published Jan. 23, 2020, titled “Composite Moderator for Nuclear Reactor Systems”; and U.S. Pat. No. 10,573,416, issued Feb. 25, 2020, titled “Nuclear Fuel Particle Having a Pressure Vessel Comprising Layers of Pyrolytic Graphite and Silicon Carbide,” the entireties of which are incorporated by reference herein. As described in those Ultra Safe Nuclear Corporation patents, the nuclear fuel can include a cylindrical fuel compact or pellet comprised of TRISO fuel particles embedded inside a silicon carbide matrix to create a cylindrical shaped nuclear fuel compact. A description of TRISO, BISO, or TRIZO fuel particles dispersed in a zirconium carbide matrix to form a cylindrical shaped nuclear fuel compact is provided in U.S. Pat. Pub. No. 2021/0005335 to Ultra Safe Nuclear Corporation of Seattle, Washington, published Jan. 7, 2021, titled “Processing Ultra High Temperature Zirconium Carbide Microencapsulated Nuclear Fuel,” the entirety of which is incorporated by reference herein.

FIG. 2D is a frontal cross-section illustration of an NTP system 100 of FIGS. 2A-C that implements the combined moderator-propellant 102, a thrust chamber 170, nozzle 171, solid control drums 220A-F (e.g., beryllium (Be)), and a solid reflector region 215. From the frontal cross-section view, the propulsion elements of the NTP system 100 including the thrust chamber 170, throat 172, and nozzle 171 are clearly visible. Additionally, the major coolant plenum 261 and the coolant intake manifold 269 can be seen. From this perspective, the notional flow of FIG. 1 can be more easily understood in the context of FIGS. 2A-C. The major coolant plenum 261 acts as a large reservoir of combined moderator-propellant 102, and is analogous to the propellant tank 151 of FIG. 1. The major coolant plenum 261, when at least partially full of combined moderator-propellant also acts as an additional radiation shield, and can protect sensitive components or humans within the lift vehicle if the major coolant plenum 261 is placed between the nuclear reactor core 101 and the sensitive components or humans.

Even without the major coolant plenum 261, however, there is both a photon shield 262 and a neutron shield 263 to protect sensitive components or humans. Much like the moderator region 113 and the control drum coolant gaps 219A-F, the photon shield 262 and neutron shield 263 are also filled with combined moderator-propellant 102, and in selective fluid communication with the combined moderator-propellant flow path 120. The combined moderator-propellant 102 can be highly pressurized in order to facilitate the functioning of the photon shield 262 and neutron shield 263.

On the combined moderator-propellant flow path 120, in order to properly distribute combined moderator-propellant 102 to the coolant channels 246A-N of the fuel assemblies 204A-N, the combined moderator-propellant 102 passes through a coolant intake manifold 269. The coolant intake manifold 269 includes an upper plate 264, and upper coolant plenum 265, a lower plate 266, and a lower coolant plenum 267. The upper coolant plenum 265 and lower coolant plenum 267 are in fluid communication with the combined moderator-propellant flow path 120, and properly structure the combined moderator-propellant 102 to serve as propellant. The coolant intake manifold 269 and the major coolant plenum 261 are protected from the radioactivity of the nuclear reactor core 101 by an inner pressure vessel 268.

Once the superheated combined moderator-propellant 102 is expelled from the coolant channels 246A-N, the superheated combined moderator-propellant 102 enters the thrust chamber 170. The thrust chamber 170 builds substantial pressure, forcing the gaseous superheated combined moderator-propellant 102 through the throat 172 and then out of the skirt 173 of the nozzle 171, thereby producing thrust. The nuclear reactor core 101 is protected from the chamber 170 by a bottom plate 270. The thrust chamber 170 is typically positioned at the bottom of the nuclear reactor core 101.

Therefore, FIGS. 2A-D depict a nuclear thermal propulsion (NTP) system 100 including a pressure vessel 260 and a nuclear reactor core 101 disposed in the pressure vessel 260. The nuclear reactor core 101 includes a moderator region 113 configured to flow a combined moderator-propellant 102 and an array of fuel assemblies 204A-N disposed within the moderator region 113. Each fuel assembly 204A-N includes a nuclear fuel 244 and an array of coolant channels 246A-N formed within the nuclear fuel 244 and coupled to the moderator region 113 to flow the combined moderator-propellant 102 to a thrust chamber 170. The combined moderator-propellant 102 can include ammonia (NH₃).

Each fuel assembly 204A-N can further include: an insulator layer (shown as an outer insulator layer 243 in FIG. 2C) surrounding the nuclear fuel 244 and the array of coolant channels 246A-N; an inner can 242 surrounding the insulator layer (shown as the outer insulator layer 243 in FIG. 2C); a combined moderator-propellant return 241 surrounding the inner can 242; and an outer can 240. The combined moderator-propellant return 241 is located between the inner can 242 and the outer can 240.

In this example, the outer can 240 can be directly coupled to the moderator region 113. The insulator layer (shown as an outer insulator layer 243 in FIG. 2C) can be formed of zirconium carbide (ZrC), and the inner insulator layers 245A-N can be formed of zirconium carbide (ZrC). The pressure vessel 260 can be formed of a titanium alloy, an aluminum stainless steel alloy, or a nickel-chromium based superalloy. The inner can 242 may be formed of a silicon carbide/silicon carbide (SiC—SiC) composite or a zirconium alloy. The outer can 240 may be formed of the SiC—SiC composite (e.g., including a different type of SiC—SiC composite than the inner can 242), a beryllium (Be) composite, or a stainless steel alloy. The nuclear fuel 244 can include coated fuel particles embedded inside a high-temperature matrix. The high temperature matrix includes silicon carbide, zirconium carbide, titanium carbide, niobium carbide, tungsten, molybdenum, or a combination thereof. The coated fuel particles can include tristructural-isotropic (TRISO) fuel particles, bistructural-isotropic (BISO) fuel particles, or TRIZO fuel particles. The BISO fuel particles can include a fuel kernel formed of uranium nitride (UN), sometimes called UN BISO fuel particles.

The NTP system 100 can include a reflector region (e.g., either a solid reflector region 215 as shown in FIGS. 2A-D or a fluid reflector region 315 as in shown in FIGS. 3A-D) disposed between the moderator region 113 and the pressure vessel 260. In the example of FIGS. 2A-D, the reflector region can be a solid reflector region 215 formed of a solid reflector material. The solid reflector material can be formed of beryllium (Be) or beryllium oxide (BeO).

The NTP system 100 can further include a coolant plenum (shown as major coolant plenum 261 in FIG. 2D) located inside the pressure vessel 260 and coupled to the moderator region 113 to store and flow the combined moderator-propellant 102 to the moderator region 113. Additionally, the NTP system 100 can include a combined moderator-propellant pump 140 (see FIG. 1). The combined moderator-propellant pump 140 is configured to pump the combined moderator-propellant 102 from the coolant plenum (shown as major coolant plenum 261) to the moderator region 113, and to pump the combined moderator-propellant from the moderator region 113 to the array of fuel assemblies 204A-N.

NTP system can include a plurality of circumferential control drums 220A-F surrounding the moderator region 113. Each of the control drums 220A-F includes a reflector portion (e.g., either a solid reflector portion 216 as shown in FIG. 2B or a fluid control drum reflector portion 316 as shown in FIG. 3B) within a first portion 231 of an outer surface 230. Each of the control drums 220A-F further includes an absorber material 217 within a second portion 232 of the outer surface 230. In the example of FIGS. 2A-D, the reflector portion of each of the control drums 220A-F can be a solid reflector portion 216 formed of a solid reflector material. The solid reflector material is formed of beryllium (Be) or beryllium oxide (BeO).

FIG. 3A is a transverse cross-section illustration of a second variation of the combined moderator-propellant NTP nuclear reactor core 101 of FIG. 1 that implements control drums 220A-F that are filled with ammonia (NH₃) and a reflector region 315 filled with ammonia. The control drums 220A-F and the reflector region can be partially or fully filled with ammonia. The nuclear reactor core 101 and NTP system 100 depicted in FIGS. 3A-D has many similar features as compared to the example nuclear reactor core 101, nuclear reactor 107, and NTP system 100 in FIGS. 2A-D. However, in FIG. 3A, the solid reflector region 215 has been replaced with a fluid reflector region 315. Therefore, in this example the fluid reflector region 315 is also is in fluid communication or selective fluid communication with the combined moderator-propellant flow path 120, along with the moderator region 113. At a certain point in the operation of the NTP system 100, the fluid reflector region 315 may be emptied and the combined moderator-propellant 102 within the fluid reflector region 315 will be pumped by the combined moderator-propellant pump 140 out of the fluid reflector region 315 and ultimately into the coolant channels 246A-N to be used as propellant for the NTP system 100. Alternatively, only portions, e.g., a subset of the solid reflector blocks(s)) of the solid reflector region 215, are replaced with liquid reflector comprised of the combined moderator-propellant 102. The combined moderator-propellant 102 may need to be pressurized within the fluid reflector region 315 in order to function in a similar manner to the solid reflector region 215.

Additionally, the solid control drum reflector portion 216 in each control drum 220A-F has been replaced with a fluid control drum reflector portion 316. Therefore, in this example the fluid control drum reflector portion 316 is also is in fluid communication or selective fluid communication with the combined moderator-propellant flow path 120, along with the moderator region 113, and the fluid reflector region 315. At a certain point in the operation of the NTP system 100, the fluid control drum reflector portion 316 of any of the control drums 220A-F may be emptied, and the combined moderator-propellant 102 within the fluid control drum reflector portion 316 will be pumped by the combined moderator-propellant pump 140 out of the fluid control drum reflector portion 316, and ultimately into the coolant channels 246A-N to be used as propellant for the NTP system 100. Alternatively, only portions of the solid control drum reflector portion 216 are replaced with the fluid control drum reflector portion 316 comprised of the combined moderator-propellant 102. The combined moderator-propellant 102 may need to be pressurized within the fluid control drum reflector portion 316 in order to function in a similar manner to the solid control drum reflector region 216.

A portion of the nuclear reactor core 101 is boxed and labeled as element 390 and this nuclear reactor core detail area 390 is magnified in FIG. 3B. Hence, FIG. 3B is a detail area 390 illustration of the transverse cross-section of the combined moderator-propellant NTP nuclear reactor core 101 of FIG. 3A. Looking into the nuclear reactor core detail area 390 shows further detail in changing the solid reflector region 215 into a fluid reflector region 315, and a solid control drum reflector portion 216 into a liquid control drum reflector portion 316. In order to keep the combined moderator-propellant 102 of the moderator region 113 separate from the combined moderator-propellant 102 of the fluid reflector region 315, a moderator reflector separator 350, which can include one or more walls, is constructed in the nuclear reactor core 101. This moderator reflector separator 350 allows for the combined moderator-propellant 102 of the moderator region 113 to be kept at a separate pressure from the combined moderator-propellant 102 of the fluid reflector region 315 when the moderator region 113 is not in fluid communication with the fluid reflector region 315.

In a similar manner, in order to keep the combined moderator-propellant 102 of the control drum coolant gaps 219A-F separate from the combined moderator-propellant 102 of the fluid control drum reflector portion 316 of the control drums 220A-F, a respective control drum reflector chamber 351A-F is formed in each control drum 220A-F. The control drum reflector chamber 351A can be a hollowed-out cavity or reservoir to hold the combined moderator-propellant 102. The control drum reflector chamber 351A can include at least one opening that is selectively opened/closed a valve that is controlled by an actuator. This control drum reflector chamber 351A-F allows for the combined moderator-propellant 102 of the control drum coolant gaps 219A-F to be kept at a separate pressure from the combined moderator-propellant 102 of the fluid control drum reflector portion 316 of the control drums 220A-F when the control drum coolant gap 219A-F is not in fluid communication with the fluid control drum reflector portion 316.

The sequence of couplings of the moderator region 113, control drum coolant gaps 219A-F, control drum reflector chambers 351A-F, fluid reflector region 315, combined moderator-propellant return 241, major coolant plenum 261, upper coolant plenum 265, and lower coolant plenum 267 can be varied, and any of the above components may flow combined moderator propellant 102 into any other component above. In this illustrated example, however, the fluid reflector region 315, control drum reflector chambers 351A-F, control drum coolant gaps 219A-F, and major coolant plenum 261, all selectively flow the combined moderator-propellant 102 into the moderator region 113. The moderator region 113 selectively flows the combined moderator-propellant 102 into the combined moderator-propellant return 241. The combined moderator-propellant return 241 flows the combined moderator-propellant 102 into the upper coolant plenum 265 and lower coolant plenum 267 of the coolant intake manifold 269. The coolant intake manifold 269 then flows the combined moderator-propellant 102 into the coolant channels 246A-N, which then flow into the thrust chamber 170, and the nozzle 171 (e.g., including throat 172 and skirt 173) before being expelled from the NTP system 100 to generate thrust.

Varying the pressure (which directly relates to density) of the combined moderator-propellant 102 in the components listed above can noticeably increase the reactivity of the nuclear reactor core 101. Higher pressure combined moderator-propellant 102 further reduces the speed of fast neutrons, more than lower pressure combined moderator-propellant 102. By increasing the pressure of the combined moderator-propellant 102 substantially, particularly in the moderator region 113, it is possible to affect the reactivity of the nuclear reactor core 101 without turning the control drums 220A-F. Therefore, the NTP system 100 that implements the combined moderator-propellant 102 can be constructed without control drums 220A-F based on the propellant density control techniques disclosed in U.S. Pat. No. 10,643,754 to Ultra Safe Nuclear Corporation of Seattle, Washington, issued May 5, 2020, titled “Passive Reactivity Control of Nuclear Thermal Propulsion Reactors” the entirety of which is incorporated by reference herein.

In FIG. 3B, a portion of the nuclear reactor core 101 is boxed and labeled as a nuclear reactor core detail area 390 and is magnified in FIG. 3C. Hence, FIG. 3C is the nuclear reactor core detail area 390 of the fuel assembly 204A of the combined moderator-propellant NTP nuclear reactor core 101 of FIG. 3A. As compared to the fuel assembly detail area 291 of FIG. 2C, there is no appreciable difference between the fuel assembly detail area 391 of FIG. 3C and the fuel assembly detail area 291 of FIG. 2C.

FIG. 3D is a frontal cross-section illustration of an NTP system 100 of FIGS. 3A-C that implements the combined moderator-propellant 102, thrust chamber 170, nozzle 171, and ammonia (NH₃) filled control drums 220A-F, and the ammonia filled reflector region 315. The only visible change as compared to the frontal cross-section illustration of FIG. 2D is replacing the solid reflector region 215 with the fluid reflector region 315. Additionally, at this viewing angle it can be seen that the moderator reflector separator 350 also separates the fluid reflector region 315 from the major coolant plenum 261, as well as from the thrust chamber 170.

Therefore, FIGS. 3A-D depict a nuclear thermal propulsion (NTP) system 100 including a pressure vessel 260 and a nuclear reactor core 101 disposed in the pressure vessel 260. The nuclear reactor core 101 includes a moderator region 113 configured to flow a combined moderator-propellant 102, and an array of fuel assemblies 204A-N disposed within the moderator region 113. Each fuel assembly 204A-N includes a nuclear fuel 244 and an array of coolant channels 246A-N formed within the nuclear fuel 244 and coupled to the moderator region 113 to flow the combined moderator-propellant to a thrust chamber 170.

The NTP system 100 can include a reflector region (e.g., either a solid reflector region 215 as shown in FIGS. 2A-D or a fluid reflector region 315 as shown in FIGS. 3A-D) disposed between the moderator region 113 and the pressure vessel 260. In the example of FIGS. 3A-D, the reflector region can be a fluid reflector region 315 configured to flow the combined moderator-propellant 102. When the reflector region is the fluid reflector region 315, a moderator reflector separator 350 can be disposed between the moderator region 113 and the fluid reflector region 315. The moderator reflector separator 350 is formed of a silicon carbide/silicon carbide (SiC—SiC) composite, beryllium (Be), or a stainless steel alloy.

NTP system 100 can include a plurality of circumferential control drums 220A-F surrounding the moderator region 113. Each of the control drums 220A-F includes a reflector portion (e.g., either a solid reflector portion 216 as shown in FIG. 2B or a fluid control drum reflector portion 316 as shown in FIG. 3B) within a first portion 231 of an outer surface 230. Each of the control drums 220A-F further includes an absorber material 217 within a second portion 232 of the outer surface 230. In the example of FIGS. 3A-D, the reflector portion 216 of each of the control drums 220A-F can be a fluid control drum reflector portion 316 that includes a control drum reflector chamber 351A configured to flow the combined moderator-propellant 102. Additionally, in the example of FIGS. 3A-D where the reflector portion is the fluid control drum reflector portion 316, the control drum reflector chamber 351A is configured to flow the combined moderator-propellant 102 while the combined moderator-propellant 102 is in a pressurized or a supercritical state.

FIG. 4A is a line graph depicting a calculated change in velocity versus a maximum payload mass of a heavy lift vehicle utilizing an NTP system with ammonia propellant, as compared to a heavy lift vehicle utilizing a propulsion system with storable bipropellant. Storable bipropellant is chosen as a comparison propellant to ammonia as it is the most common non-cryogenic propellant in space propulsion technology in the thrust class of NH₃ NTP system 100. It is assumed for the following calculations that the NH₃ NTP system 100 has an engine mass of 1000 kg, specific impulse (Iₛₚ) of 470 seconds and a non-engine inert mass to propellant fraction of 0.080. A storable bipropellant system is assumed to have engine mass of 95 kg, and Iₛₚ of 328 seconds, and non-engine inert mass to propellant fraction of 0.134.

In FIG. 4A, the performance calculations heavy lift vehicle plot 400A depicts the amount of delta-v 410 thrust a heavy lift vehicle can achieve for a given maximum payload mass 415 with either the NH₃ NTP system 100, shown as the NH₃ NTP performance line 401, and the storable bipropellant system, shown as the storable bipropellant performance line 402. A heavy lift is, for example, a New Glenn or Falcon Heavy lift vehicle.

The performance calculations heavy lift vehicle plot 400A shows that the NH₃ NTP system 100 is more efficient over the storable bipropellant system. The NH₃ NTP performance line 401 is to the right of the storable bipropellant performance line 402, and the storable bipropellant performance line 402 never crosses the NH₃ NTP performance line 401. Additionally, the NH₃ NTP system 100 is able to transport between 2,500 kg and 4,000 kg more in maximum payload mass 415 for any given reasonable delta-v 410 mission velocity. The NH₃ NTP system 100 is able to produce 700 to 3000 km/s more in delta-v 410 velocity for any reasonable maximum payload mass 415.

A central theme of FIGS. 4A-C and 5A-B is that the combined moderator-propellant 102 is more efficient by payload 415 at a desired delta-v 410 than traditional in space chemical propulsion systems that use a storable bipropellant. For example, the storable bipropellant is dinitrogen tetroxide (N₂O₄)/ Monomethylhydrazine (MMH) propellant. MMH is a storable liquid fuel that found favor in the United States for use in orbital spacecraft engines. The most common of the traditional in space chemical propulsion systems use storable hypergolic propellants.

FIG. 4B is a line graph depicting capabilities for calculated delta-v (change in velocity) 410 versus a ratio of payload capability of a heavy lift vehicle utilizing an NTP system with ammonia propellant as the in-space propulsion stage compared to utilizing a storable bipropellant. The line graph depicts capabilities for calculated delta-V (change in velocity) 410 versus the ratio of the maximum payload mass 415 of two alternative heavy lift vehicles. The ratio of the maximum payload mass 415 compares a heavy lift vehicle utilizing the NTP system 100 with ammonia propellant as the in-space propulsion stage (as described in the NH₃ NTP performance line 401 of FIG. 4A) to a heavy lift vehicle utilizing an in-space propulsion stage with storable bipropellant (as described in the storable bipropellant performance line 402 of FIG. 4A).

Hence, in FIG. 4B, the NH₃ NTP to storable bipropellant payload ratio line 403 is the payload capability of a heavy lift vehicle that implements the NTP system with ammonia propellant (as described in the NH₃ NTP performance line 401 of FIG. 4A) divided by the same heavy lift vehicle that implements storable bipropellant (as described in the storable bipropellant performance line 402 of FIG. 4A). As the delta-V increases to approximately 6.5 km/s the payload capability of heavy lift vehicle utilizing an in-space propulsion stage storable bipropellant drops to zero and line 403 asymptotes to infinity. Beyond a delta-V of 6.5 km/s are spacecraft missions or operation not possible with a heavy lift vehicle utilizing storable bipropellant as the in-space propulsion stage but which are possible with a heavy lift vehicle utilizing the NTP system 100 with ammonia propellant.

FIG. 4C is the line graph of FIG. 4A on a performance calculation heavy lift vehicle plot 400C, with an overlay of various representative payloads 430A-D and various representative missions 425A-D achievable with a given delta-v (change in velocity) 410.

Geo mission equivalent 425A is the amount of delta-V 410 needed to move a heavy lift vehicle into a geospatial orbit, or an equivalent mission. Fast Mars orbit one way equivalent 425B is the amount of delta-V 410 needed to move a heavy lift vehicle into an orbit of Mars with no return to Earth, or an equivalent mission. LLO (lunar orbit) round trip equivalent 425C is the amount of delta-V 410 needed to move a heavy lift vehicle into an orbit of the moon with a return to Earth, or an equivalent mission. Ryugu round trip equivalent 425D is the amount of delta-V 410 needed to move a heavy lift vehicle to the Ryugu asteroid with a return to Earth in a manner similar to the Hayabusa2 mission, or an equivalent mission.

New Horizons dry mass equivalent 430A is the mass of the New Horizons spacecraft, or an equivalent mass. X-37B dry mass equivalent 430B is the mass of the X-37 Boeing orbital test vehicle, or an equivalent mass. GOES-17 weather satellite equivalent 430C is the mass of the GOES-17 environmental satellite, or an equivalent mass. Two average GEO satellite equivalent 430D is the average mass of two geospatial satellites, or an equivalent mass.

As in FIG. 4A, the performance calculations heavy lift vehicle plot 401C shows that the NH₃ NTP system 100 is more efficient over the storable bipropellant system because the NH₃ NTP performance line 401 is to the right of the storable bipropellant performance line 402, and the storable bipropellant performance line 402 never crosses the NH₃ NTP performance line 401. In addition to the insights from FIG. 4A, it can be discerned that the NH₃ NTP system 100 can send between six and ten times as much payload on an LLO round trip equivalent 425C mission. The NH₃ NTP system 100 is also capable of transporting two average GEO satellites equivalents 430D into geospatial orbit on a GEO mission equivalent 425A. The storable bipropellant system is unable to transport two satellites into geospatial orbit.

FIG. 5A is a line graph depicting a calculated change in velocity versus a maximum payload mass of a medium lift vehicle utilizing an NTP system with ammonia propellant, as compared to a heavy lift vehicle utilizing a propulsion system with storable bipropellant. A medium lift is, for example, a Falcon 9 or Vulcan lift vehicle.

In the performance calculations medium lift vehicle plot 500A of FIG. 5A, the curves of the NH₃ NTP performance line 501 and the storable bipropellant performance line 502 are very similar to the NH₃ NTP performance line 401 and the storable bipropellant performance line 402 of FIG. 4A. However, NH₃ NTP performance line 401 of FIG. 4A has an X-intercept at around 10 km/s delta-V, and a Y-intercept near 17,500 kg maximum payload mass 415, whereas NH₃ NTP performance line 501 of FIG. 5A has an X-intercept at around 9 km/s delta-V, and a Y-intercept near 9,000 kg maximum payload mass 415.

Likewise, storable bipropellant performance line 402 of FIG. 4A has an X-intercept at around 6.75 km/s delta-V, and a Y-intercept near 15,000 kg maximum payload mass 415, whereas storable bipropellant performance line 502 of FIG. 5A has an X-intercept at around 6.75 km/s delta-V, and a Y-intercept near 8,000 kg maximum payload mass 415.

FIG. 5B is a line graph depicting capabilities for calculated delta-v (change in velocity) 410 versus a ratio of payload capability of a medium lift vehicle utilizing an NTP system with ammonia propellant as the in-space propulsion stage compared to a storable bipropellant. The line graph depicts capabilities for calculated delta-V (change in velocity) 410 versus the ratio of the maximum payload mass 415 of two alternative medium lift vehicles. The ratio of the maximum payload mass 415 compares a medium lift vehicle utilizing an NTP system 100 with ammonia propellant as the in-space propulsion stage (as described in the NH₃ NTP performance line 501 of FIG. 5A) to a medium lift vehicle utilizing an in-space propulsion stage with storable bipropellant (as described in the storable bipropellant performance line 502 of FIG. 5A). The NH₃ NTP / storable bipropellant payload capabilities 420 is a ratio. Accordingly, the NH₃ NTP to storable bipropellant payload ratio line 503 shown in the performance calculations medium lift vehicle plot 500B of FIG. 5B appears identical to the NH₃ NTP to storable bipropellant payload ratio line 403 shown in the performance calculations heavy lift vehicle plot 400B of FIG. 4B.

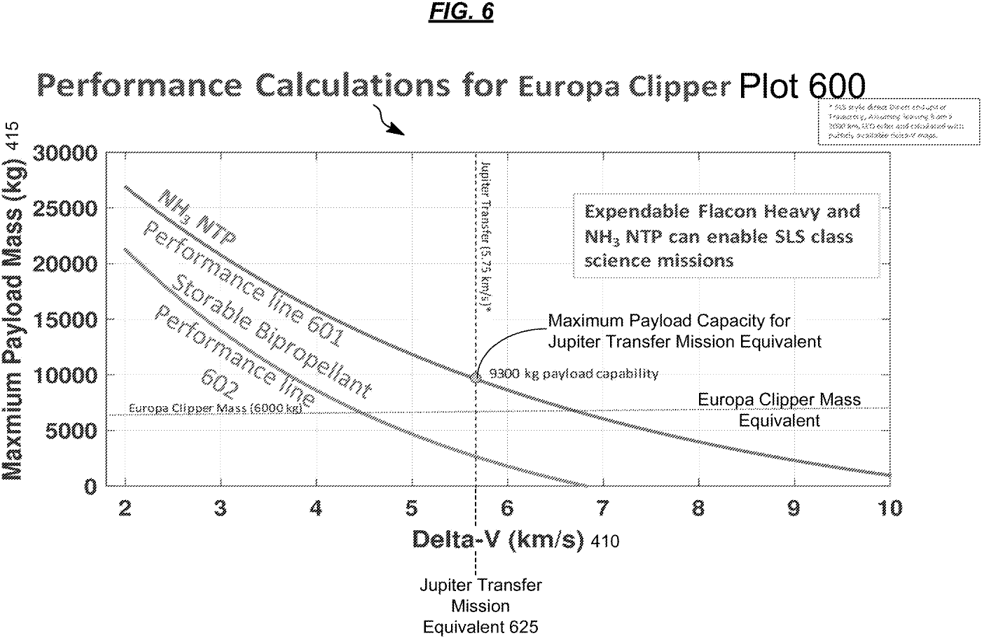

FIG. 6 is a line graph depicting a calculated change in velocity versus a maximum payload mass of a Europa Clipper spacecraft utilizing an NTP system with ammonia propellant, as compared to a Europa Clipper spacecraft utilizing a propulsion system with storable bipropellant.

In the depicted performance calculations Europa Clipper plot 600, the curves of the NH₃ NTP performance line 601 and the storable bipropellant performance line 602 of FIG. 6 are very similar to the NH₃ NTP performance line 401 and the storable bipropellant performance line 402 of FIG. 4A. However, NH₃ NTP performance line 401 has an X-intercept at around 10 km/s delta-V, and a Y-intercept near 17,500 kg maximum payload mass 415, whereas NH₃ NTP performance line 601 has an X-intercept at around 10.5 km/s delta-V, and a Y-intercept near 28,000 kg maximum payload mass 415.

Likewise, storable bipropellant performance line 402 has an X-intercept at around 6.75 km/s delta-V, and a Y-intercept near 15,000 kg maximum payload mass 415, whereas storable bipropellant performance line 602 has an X-intercept at around 6.75 km/s delta-V, and a Y-intercept near 24,000 kg maximum payload mass 415.

The performance calculation Europa Clipper plot 600 indicates that the NH₃ NTP system 100 would be able to transport 9,300 kg on a Jupiter transfer mission equivalent 625: meaning a 300 kg net payload could be transported. The storable bipropellant system is unable to generate enough Delta-V 410 to transport an unladen Europa Clipper on a Jupiter Transfer mission equivalent 625A, as the Europa Clipper is itself too massive.

Therefore, FIGS. 4-6 demonstrate that the improved efficiency of the ammonia-based NTP system 100 has made many more missions available, as the ammonia-based NTP system can move more payload further than the existing storable bipropellant system in all reasonable scenarios. The ammonia-based NTP system 100 also has a higher delta-V 410 velocity, around 10-11 km/s, as evidenced by the consistency of the X-intercepts of the NH₃ NTP performance lines 401, 501, 601, as compared to the maximum delta-V 410 of the storable bipropellant system, around 6.75 km/s, as evidenced by the consistency of the X-intercepts of the storable bipropellant performance lines 402, 502, 602.

FIG. 7 is a chart comparing a pressurized NH₃ propellant tank 751 to a cryogenic H₂ propellant tank 752 that is notional. In particular, FIG. 7 depicts a representative case 10,000 kg of propellant chart 700. This chart 700 depicts the size differences between a pressurized NH₃ propellant tank 751 and a cryogenic H₂ propellant tank 752.

The pressurized NH₃ propellant tank 751 has a pressurized NH₃ propellant tank diameter 721 of 3.2 meters (m) in order to hold 10,000 kg of pressurized NH₃ propellant 701. This pressurized NH₃ propellant tank diameter 721 of 3.2 meters results in an area of 10.24 meters squared (m²) and a volume of 68.9 meters cubed (m³).

The cryogenic H₂ propellant tank 752 would have a cryogenic H₂ propellant tank height 722 of 11.2 m, and a cryogenic H₂ propellant tank diameter 732 of 4 m. This notional cryogenic H₂ propellant tank height 722 of 11.2 m and notional cryogenic H₂ propellant tank diameter 732 of 4 m results in a top area of 16 m², a side area of 44.8 m², and a volume of 179.2 m³. Therefore, the volume of the notional pressurized NH₃ propellant tank 751 required to store the same mass of propellant as the notional cryogenic H₂ propellant tank 752 is one third, which is a significant mass and form factor savings. Additionally, because the height reduction is so significant moving from the tall cylindrical notional cryogenic H₂ propellant tank 752 to the pressurized NH₃ propellant tank 751 that is spherical shaped, the pressurized NH₃ propellant tank 751 has a smaller form factor and thus will be able to fit in substantially more NTP systems, while also utilizing smaller and more efficient fairings. Additionally, the pressurized NH₃ propellant tank 751 is more likely to fit into fairings currently utilized in existing NTP systems, whereas the cryogenic H₂ propellant tank 752 will fit in far fewer existing fairings, and would require substantial redesign of the existing fairings of existing NTP systems.

In addition, due to the fact that hydrogen propellant as used in many NTP concepts must be stored at cryogenic temperatures (< 30 Kelvin (K)), the mass of a notional cryogenic H₂ propellant tank 752 to store H₂ and the equipment for keeping H₂ cryogenic are quite large. As a particular example, in order to store 10,000 kg of cryogenic H₂ propellant 702, the cryogenic H₂ propellant tank 752 would weigh an additional 8,621 kilograms (kg). As an alternative, 10,000 kg pressurized NH₃ propellant 701 would only have a pressurized NH₃ propellant tank 751 weighing an additional 780 kg. This results in a 600 kilogram per cubic meter (kg/m³) propellant density for NH₃ in the pressurized NH₃ propellant tank 751, as opposed to a 71 kg/m³ propellant density for cryogenic H₂ propellant 702 in the notional cryogenic H₂ propellant tank 752. Additionally, cryogenic H₂ propellant 702 is only a liquid up to 253° C., as opposed to pressurized NH₃ propellant 701 which is liquid up to 47° C. (C) at 2 megapascals (MPa). Liquids are more suited to acting as a moderator than gases, and so cryogenic H₂ propellant 702 is unlikely to serve well as a combined moderator-propellant 102. Therefore, using the pressurized NH₃ propellant 701 as the combined moderator-propellant 102 removes the difficulties associated with the cryogenic H₂ propellant 702 normally used in NTP systems.

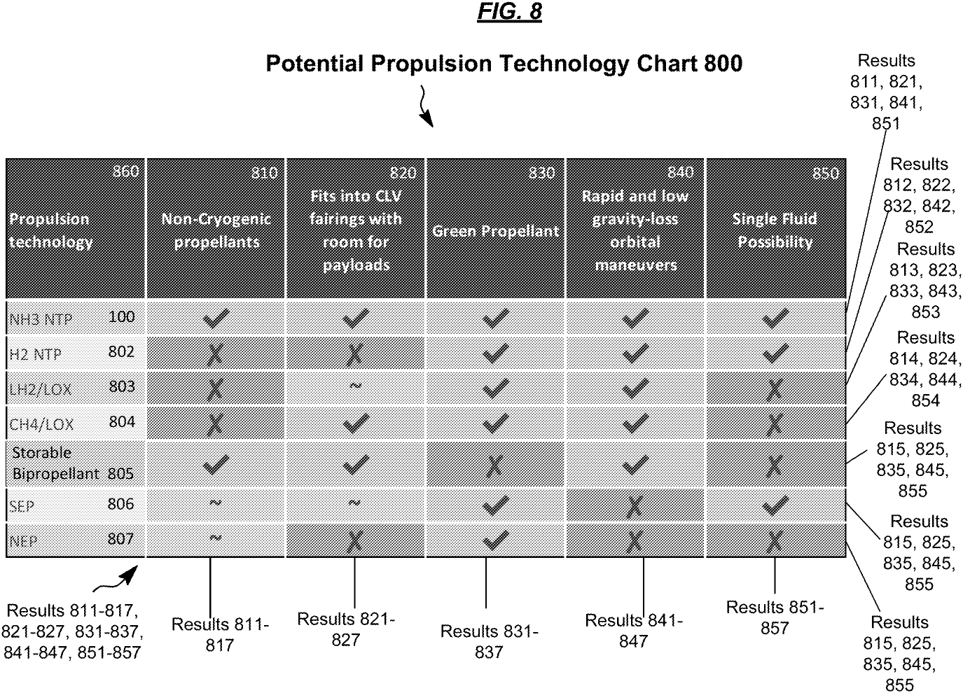

FIG. 8 is a chart comparing and contrasting the feasibility of utilizing various propulsion technologies for extraterrestrial propulsion systems. The potential propulsion technology chart 800 has a column of propulsion technologies 860, which can be selected from to choose a method for propelling an extraterrestrial vehicle. The column of propulsion technologies 860 includes a combined moderator-propellant NTP system 100 based on ammonia (NH₃) as described FIG. 1-3D, an H₂ NTP system 802, an LH₂ liquid oxygen (LOX) system 803, a CH4 LOX system 804, a storable bipropellant system 805, a solar electric propulsion (SEP) system 806, and a nuclear electric propulsion (NEP) system 807.

The potential propulsion technology chart 800 has row headers identifying criteria for determining whether a certain propulsion technology 860 is suited for a particular extraterrestrial mission. The criteria include: utilizing non-cryogenic propellants 810; whether the technology fits into commercial launch vehicle (CLV) fairings with room for payloads 820; whether the propulsion technology is green 830 like the propulsion technology tested for the Green propellant infusion mission by NASA; whether the propulsion technology is performs well in rapid and low gravity-loss orbital maneuvers 840; and whether the technology utilizes no more than a single fluid 850. As the results 811-817, 821-827, 831-837, 841-847, 851-857 indicate, only the NH₃ NTP system 100 has results 811, 821, 831, 841, 851 with all passing marks. All other propulsion technologies 802-807 disclosed have some failing results 812-814, 822, 827, 835, 846-847, 853-855, 857 indicating that those technologies 802-807 are not as suited to extraterrestrial propulsion as the NH₃ NTP system 100 based on these criteria 810, 820, 830, 840, 850. In particular, H₂ NTP 802 as discussed in FIG. 7 fails to fit into existing fairings in use, and so fails the criteria of fitting into commercial launch vehicle (CLV) fairings with room for payloads. Storable bipropellant 805 appears to be a reasonable competitor to NH₃ NTP 801, but as explored in FIGS. 4A-6, storable bipropellant 805 has generally inferior performance across all performance metrics.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” “has,” “having,” “containing,” “contain”, “contains,” “with,” “formed of,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

1. A nuclear thermal propulsion system comprising:
a pressure vessel; and
a nuclear reactor core disposed in the pressure vessel, including:
a moderator region configured to flow a combined moderator-propellant; and
an array of fuel assemblies disposed within the moderator region, wherein each fuel assembly includes:
a nuclear fuel, and
an array of coolant channels formed within the nuclear fuel and coupled to the moderator region to flow the combined moderator-propellant to a thrust chamber.

2. The nuclear thermal propulsion system of claim 1, wherein:
the combined moderator-propellant includes ammonia (NH₃).

3. The nuclear thermal propulsion system of claim 1, wherein each fuel assembly further includes:
an insulator layer surrounding the nuclear fuel and the array of coolant channels;
an inner can surrounding the insulator layer;
a combined moderator-propellant return surrounding the inner can; and
an outer can, wherein the combined moderator-propellant return is located between the inner can and the outer can.

4. The nuclear thermal propulsion system of claim 3, wherein:
the outer can is directly coupled to the moderator region.

5. The nuclear thermal propulsion system of claim 3, wherein:
the insulator layer is formed of zirconium carbide (ZrC).

6. The nuclear thermal propulsion system of claim 3, wherein:
the pressure vessel is formed of a titanium alloy, an aluminum stainless steel alloy, or a nickel-chromium based superalloy.

7. The nuclear thermal propulsion system of claim 3, wherein:
the inner can is formed of a silicon carbide/silicon carbide (SiC—SiC) composite or a zirconium alloy; and
the outer can is formed of the SiC—SiC composite, a beryllium (Be) composite, or a stainless steel alloy.

8. The nuclear thermal propulsion system of claim 3, wherein:
the nuclear fuel is comprised of coated fuel particles embedded inside a high-temperature matrix; and
the high-temperature matrix includes silicon carbide, zirconium carbide, titanium carbide, niobium carbide, tungsten, molybdenum, or a combination thereof.

9. The nuclear thermal propulsion system of claim 8, wherein:
the coated fuel particles include tristructural-isotropic (TRISO) fuel particles, bistructural-isotropic (BISO) fuel particles, or TRIZO fuel particles.

10. The nuclear thermal propulsion system of claim 9, wherein:
the BISO fuel particles include a fuel kernel formed of uranium nitride (UN).

11. The nuclear thermal propulsion system of claim 1, further comprising a reflector region disposed between the moderator region and the pressure vessel.

12. The nuclear thermal propulsion system of claim 11, wherein the reflector region is formed of a solid reflector material.

13. The nuclear thermal propulsion system of claim 12, wherein the solid reflector material is formed of beryllium (Be) or beryllium oxide (BeO).

14. The nuclear thermal propulsion system of claim 11, wherein the reflector region is configured to flow the combined moderator-propellant.

15. The nuclear thermal propulsion system of claim 14, further comprising:
a moderator reflector separator disposed between the moderator region and the reflector region,
wherein the moderator reflector separator is formed of a silicon carbide/silicon carbide (SiC—SiC) composite, beryllium (Be), or a stainless steel alloy.

16. The nuclear thermal propulsion system of claim 1, further comprising:
a coolant plenum located inside the pressure vessel and coupled to the moderator region to store and flow the combined moderator-propellant to the moderator region.

17. The nuclear thermal propulsion system of claim 16, further comprising a combined moderator-propellant pump, wherein:
the combined moderator-propellant pump is configured to:
pump the combined moderator-propellant from the coolant plenum to the moderator region; and
pump the combined moderator-propellant from the moderator region to the array of fuel assemblies.

18. The nuclear thermal propulsion system of claim 1, further comprising:
a plurality of circumferential control drums surrounding the moderator region,
wherein each of the control drums includes a reflector portion within a first portion of an outer surface and an absorber material within a second portion of the outer surface.

19. The nuclear thermal propulsion system of claim 18, wherein the reflector portion is formed of a solid reflector material.

20. The nuclear thermal propulsion system of claim 19, wherein the solid reflector material is formed of beryllium (Be) or beryllium oxide (BeO).

21. The nuclear thermal propulsion system of claim 18, wherein the reflector portion includes a control drum reflector chamber configured to flow the combined moderator-propellant.

22. The nuclear thermal propulsion system of claim 21, wherein the control drum reflector chamber is configured to flow the combined moderator-propellant while the combined moderator-propellant is in a pressurized or a supercritical state.
